(19) United States
(12) Patent Application Publication
(10) Pub. No.: US 2026/0135380 A1
(43) Pub. Date: May 14, 2026

(54) Power Delivery Over a Common Bus Using Fault Managed Power

(71) Applicant: VoltServer Inc., East Greenwich, RI (US)

(72) Inventors: Jeffrey A. Weiss, Lincoln, RI (US); Stephen S. Eaves, Charlestown, RI (US); Jonathan J. Casey, North Kingstown, RI (US)

(21) Appl. No.: 19/306,479

(22) Filed: Aug. 21, 2025

Related U.S. Application Data
(60) Provisional application No. 63/685,665, filed on Aug. 21, 2024.

(51) Int. Cl. H02J 3/001; H02J 3/32; H02J 3/38; H02J 13/12; H02J 13/13; H02J 13/181; H02J 13/183; H02J 101/10; H02J 101/24

(52) U.S. Cl. CPC H02J 3/001; H02J 3/32; H02J 3/381; H02J 13/12; H02J 13/1313; H02J 13/181; H02J 13/183; H02J 2101/10; H02J 2101/24

(57) ABSTRACT

A fault managed power (FMP) transmitter for use in an electrical power system, having a power source port configured to be connected to a first electrical power source of the plurality of electrical power sources and an power bus port configured to be electrically connected to the common electrical bus. There is at least one switch between the power source port and the power bus port and processing circuitry configured to control the at least one switch to receive power from the first electrical power source and to transmit FMP output pulses via the power bus port over the common electrical bus to the FMP receiver. The processing circuitry is configured to receive an external timing trigger to enable the processing circuitry to synchronize the transmission of the FMP output pulses with the transmission of FMP output pulses from each of the at least one other FMP transmitter.

### CROSS-REFERENCE TO RELATED APPLICATION

This application claims the benefit of U.S. application Ser. No. 63/685,665, filed Aug. 21, 2024, which is incorporated herein by reference in its entirety.

### TECHNICAL FIELD

The present disclosure relates to systems using fault managed power (FMP) to more safely deliver power from multiple sources to a common electrical bus and to systems with power sources having electric storage devices to receive FMP from the bus to charge the electric storage devices.

### BACKGROUND ART

One application having multiple power sources connected to a common bus to consolidate power and deliver it to users via an electric distribution system, transmission system, a micro-grid, or even a larger single user such as a commercial or industrial site is solar power systems. Such solar power systems may have battery installations to store solar generated power. Typically, multiple panels individually or sets of aggregated panels deliver power to DC strings or parallel buses in either a DC or AC format. In order to conserve the amount of wire/cabling and improve efficiency, they tend to operate at high AC or DC voltages. For example, a DC string may be created where multiple solar panels, each supplying power at less than 50 volts DC, are connected in series to create a high voltage DC bus which then arrives at a DC to AC inverter to provide AC power to an AC power grid. In some commercially available systems, this voltage may be as high as 1,500 volts DC. In some systems one or more generators may also be used to provide backup power as required.

When power is passed sequentially in a daisy chain fashion between solar panels or power modules such as described in U.S. Pat. No. 9,853,689, this has the disadvantage of requiring the last transmission electronics to receive and deliver the entire power requirement of the string, making the power transmitters and power receivers more expensive than is necessary for this application. Furthermore, this solution is susceptible to single points of failure.

Such high voltage systems can be dangerous for installers, maintenance workers, and other workers needing to be near these systems, as they present a serious electrocution risk. They can also cause electrical fires, which for rooftop installation can be particularly dangerous. With risk of electrical fires, these systems may expose fire fighters to potential electrocution if they are fighting a fire on the roof of or in a building with active solar panels.

### SUMMARY OF THE EMBODIMENTS

The benefits and advantages of the present disclosure over existing systems will be readily apparent from this Summary of the Embodiments and the Detailed Description of Specific Embodiments to follow.

One skilled in the art will appreciate that the present teachings can be practiced with embodiments other than those summarized or disclosed below.

In one aspect the disclosure features a fault managed power (FMP) transmitter configured to connect a first electrical power source to a common electrical bus as part of an FMP electrical system. The FMP electrical system also includes at least one FMP receiver and at least one other FMP transmitter, each connected to the common electrical bus. The FMP transmitter comprising: a source port configured to be connected to the at least one electrical power source, a power bus port configured to be electrically connected to the common electrical bus, and at least one switch between the source port and the power bus port. There is processing circuitry configured to control the at least one switch to receive power from the first electrical power source and to transmit FMP output pulses via the power bus port over the common electrical bus to the FMP receiver. The processing circuitry is configured to receive an external timing trigger to enable the processing circuitry to synchronize transmission of the FMP output pulses with the transmission of FMP output pulses over the common electrical bus from the at least one other FMP transmitter connected to one of the first electrical power source or a second electrical power source.

In other aspects of the disclosure one or more of the following features may be included, specifically they are applicable to the fault managed power (FMP) transmitter described in the previous paragraph and each of the features may be combined with any other feature listed. The at least one other FMP transmitter may be connected to the first electrical power source to output FMP pulses over the common electrical bus. The at least one other FMP transmitter may be connected to the second electrical power source to output FMP pulses over the common electrical bus. The processing circuity may include a digital signal processor. A voltage level of the FMP output pulses may be substantially equivalent to the voltage level of FMP output pulses of the at least one other FMP transmitter. The processing circuitry may be configured to transmit the FMP output pulses synchronized with the FMP output pulses of the at least one other FMP transmitter during power transfer periods and wherein the processing circuitry is configured to cease transmission of FMP output pulses during sample periods between power transfer periods. The processing circuitry may be configured to monitor the common electrical bus for faults during sample periods and, if a fault is detected, to control the at least one switch to terminate the transmission of FMP output pulses to the common electrical bus. The first electrical power source may be one or more of a solar power source, a battery power source, and a generator power source. The first electrical power source may include a battery power source and wherein the battery power source is rechargeable. The processing circuitry may be configured to control the at least one switch to receive the synchronized FMP output pulses from the common electrical bus. There may further be included a capacitor connected to the at least one switch to receive the synchronized FMP output pulses and to output DC power and a first converter device connected to the capacitor and configured to convert the DC power from a first voltage level to a second voltage level; wherein the FMP transmitter and the converter device are integrated into an FMP power module device and wherein the at least one FMP receiver is integrated into a gateway module including a second converter configured to receive the output of the FMP receiver, convert the output to a form of power required for an electric grid. The processing circuitry may be configured to synchronize transmission of the output pulses using a master-slave process. The processing circuitry may be configured to operate as a master and the at least one other FMP transmitter operates as slaves. The processing circuitry may be configured to operate as a slave and receive the external timing trigger from the at least one other FMP transmitter operating as a master. The external timing trigger may be a leading edge of a FMP output pulse from the at least one other FMP transmitter operating as the master. The processing circuitry may be configured to receive the external timing trigger from one of i) the at least one other FMP transmitter, ii) the at least one FMP receiver, or iii) a management device. The FMP transmitter may be further configured to one of generate a modulated timing signal on the FMP output pulses as the timing trigger or output FMP output pulse from which the at least one other FMP transmitter uses the leading edge as the timing trigger. The processing circuitry may be configured to output current based on one or more of a power requirement of the FMP receiver, an impedance of the common electrical bus, and a voltage at the output of the at least one other FMP transmitter. The processing circuitry and the at least one other FMP transmitter may be configured to adjust the voltage of the FMP output pulses in order share the power load with the first and second electrical power sources. The processing circuitry and the at least one other FMP transmitter may be configured to adjust the voltage of the FMP output pulses based on a state of charge of the rechargeable battery. The processing circuitry may be configured to selectively apply a predetermined bias voltage during sample periods. The processing circuitry may be configured to detect a fault based on a predetermined aggregate bias applied by the FMP transmitter and the at least one other FMP transmitter during a sample period. The FMP transmitter may be configured to be connected in parallel to the common electrical bus. There may be more than two electrical power sources, together constituting a plurality of electrical power sources, and there are more than at least one other FMP transmitter, together constituting a plurality of other FMP transmitters; and wherein each of the plurality of other FMP transmitters is connected to at least one of the plurality of electrical power sources; and wherein each of the plurality of other FMP transmitters are connected to the common power bus and output synchronized FMP output pulses.

In another aspect the disclosure features a method for transferring fault managed power (FMP) from a first electrical power source to a common electrical bus via a FMP transmitter in a FMP electrical system. The FMP electrical system also includes at least one FMP receiver and at least one other FMP transmitter, each connected to the common electrical bus, the method comprising: connecting the first electrical power source to a first FMP transmitter having at least one switch, connecting the first FMP transmitter to the common electrical bus, and controlling the at least one switch to receive power from the first electrical power source and to transmit FMP output pulses over the common electrical bus. The step of controlling includes receiving an external timing trigger to enable transmission of the FMP output pulses of the first FMP transmitter to be synchronized with the transmission of FMP output pulses by the at least one other FMP transmitter.

In other aspects of the disclosure one or more of the following features may be included, specifically they are applicable to the fault managed power (FMP) method described in the previous paragraph and each of the features may be combined with any other feature listed. The method may include connecting the at least one other FMP transmitter to the first electrical power source to output FMP pulses over the common electrical bus. The method may include connecting the at least one other FMP transmitter to the second electrical power source to output FMP pulses over the common electrical bus. A voltage level of the FMP output pulses of the first FMP transmitter may be substantially equivalent to the voltage level of FMP output pulses of the at least one other FMP transmitter. The method may include transmitting the FMP output pulses of the first FMP transmitter synchronized with the FMP output pulses of the at least one other FMP transmitter during power transfer periods and ceasing transmission of FMP output pulses of the first transmitter and of at least one other FMP transmitter during sample periods between power transfer periods. The method may include monitoring the common electrical bus for faults during sample periods and, if a fault is detected, controlling the at least one switch to terminate the transmission of FMP output pulses to the common electrical bus. The first electrical power source may be one or more of a solar power source, a battery power source, and a generator power source. The first electrical power source may include a battery power source and wherein the battery power source is rechargeable. The method may include controlling the at least one switch to receive the synchronized FMP output pulses from the common electrical bus. The method may include connecting a capacitor to the at least one switch to receive the synchronized FMP output pulses and output DC power and connecting a first converter device to the capacitor to convert the DC power from a first voltage level to a second voltage level; wherein the method further includes integrating the FMP transmitter and the first converter device into an FMP power module device and integrating the at least one FMP receiver into a gateway module including providing a second converter to receive the output of the FMP receiver, convert the output to a form of power required for an electric grid. The method may include synchronizing transmission of the output pulses using a master-slave process. The method may include operating the first FMP transmitter as a master and operating the at least one other FMP transmitter as a slave. The method may include operating the first FMP transmitter as a slave and receiving the external timing trigger from the at least one other FMP transmitter operating as a master. The external timing trigger may be a leading edge of a FMP output pulse or a modulated timing signal on the FMP output pulses from of the at least one other FMP transmitter operating as the master. The method may include receiving the external timing trigger from one of i) the at least one other FMP transmitter, ii) the at least one FMP receiver, or iii) a management device. The method may include the first FMP transmitter undertaking one of generating a modulated timing signal on the FMP output pulses as the timing trigger or providing an FMP output pulse from which the at least one other FMP transmitter uses the leading edge as the timing trigger. The method may include using the first FMP transmitter to output current based on one or more of a power requirement of the FMP receiver, an impedance of the common electrical bus, and a voltage at the output of the at least one other FMP transmitter. The method may include controlling the first transmitter and the at least one other FMP transmitter to adjust the voltage of the FMP output pulses in order share the power load with the first and second electrical power sources. The method may include adjusting the voltage of the FMP output pulses based on a state of charge of the rechargeable battery. The method may include selectively applying a predetermined bias voltage using the first FMP transmitter during sample periods. The method may include detecting by the first FMP transmitter a fault based on a predetermined aggregate bias applied by the first FMP transmitter and the at least one other FMP transmitter during a sample period. The method may include connecting the first FMP transmitter in parallel to the common electrical bus. The method may include providing more than two electrical power sources, together constituting a plurality of electrical power sources, and providing more than at least one other FMP transmitter, together constituting a plurality of other FMP transmitters; and including connecting each of the plurality of other FMP transmitters to at least one of the plurality of electrical power sources and connecting each of the plurality of other FMP transmitters to the common power bus to output synchronized FMP output pulses.

In yet a further aspect the disclosure features a fault managed power (FMP) receiver for use in an electrical power system, wherein the electrical power system includes at least one power source connected to a common electrical bus via at least two FMP transmitters. The FMP receiver comprising: a power bus port configured to be connected to the common electrical bus and configured to receive synchronized FMP output pulses from the at least two FMP transmitters transmitted over the common electrical bus; a power grid port configured to be connected to an electric grid; and at least one switch between the power bus port and the power grid port. There is processing circuitry configured to control the at least one switch to receive the synchronized FMP output pulses from the common electrical bus.

In further aspects of the disclosure one or more of the following features may be included, specifically they are applicable to the fault managed power (FMP) receiver described in the previous paragraph and each of the features may be combined with any other feature listed. There may be included a converter device connected to the at least one switch and configured to output a required form of power to the electric grid; wherein the converter device and the FMP receiver are integrated into a gateway module. The processing circuity may include a digital signal processor. The FMP receiver may control the at least one switch to receive FMP output pulses during power transfer periods from the at least two FMP transmitters and wherein the FMP receiver controls the at least one switch disconnect from the common power bus when the at least two FMP transmitters cease transmission of FMP output pulses during sample periods between power transfer periods. The processing circuitry may be configured to monitor the common electrical bus for faults during sample periods and, if a fault is detected, it is configured to send a signal to the at least two FMP transmitters to terminate transmission of FMP output pulses to the common electrical bus. The first electrical power source may be one or more of a solar power source, a battery power source, and a generator power source. The first electrical power source may include a battery power source and wherein the battery power source is rechargeable. The converter device may be configured to receive power from the electric grid in the required form of power for the electric grid and output converted power; and wherein the processing circuitry may be configured to control the at least one switch to receive the converted power and to transmit FMP output pulses over the common electrical bus; wherein the processing circuitry may be configured to receive an external timing trigger to enable the processing circuitry to synchronize the transmission of the FMP output pulses with the transmission of FMP output pulses from the at least two FMP transmitters. The processing circuitry may be configured to operate as a master and synchronize transmission of the FMP output pulses from the at least two FMP transmitters using a master-slave process. The processing circuitry may be configured to operate as a slave and receive the external timing trigger from one of the at least two FMP transmitters operating as a master. The processing circuitry may be configured to receive the external timing trigger from one of i) one of the at least two FMP transmitters, or ii) a management device. The external trigger may be a modulated timing signal on the FMP pulses by one of the at least two FMP transmitters. The processing circuitry may be configured to output current based on one or more of an impedance of the common electrical bus and a voltage at the output of the at least two FMP transmitters. The processing circuitry may be configured to adjust a voltage of the FMP output pulses based on a state of charge of a power source including a rechargeable battery. The processing circuitry may be configured to selectively apply a predetermined bias voltage during sample periods. The processing circuitry may be configured to detect a fault based on a predetermined aggregate bias applied by one or more of the at least two FMP transmitters and the FMP receiver during a sample period. The FMP receiver may further include a first capacitor connected between the output of the at least one switch and the converter device to receive the FMP output pulses and output DC power to the converter device. The FMP receiver may further include a second capacitor connected between the output of the at least one switch and the converter device to receive the required form of power from the electric grid and output DC power to the at least one switch.

In an additional aspect the disclosure features a method for receiving fault managed power (FMP) by an FMP receiver in an electrical power system, wherein the electrical power system includes at least one power source connected to a common electrical bus via at least two FMP transmitters. The method includes connecting a power bus port of the FMP receiver to the common electrical bus to receive synchronized FMP output pulses from the at least two FMP transmitters; connecting a power grid port to an electric grid; and connecting at least one switch between the power bus port and the power grid port. The method also includes controlling the at least one switch to receive the synchronized FMP output pulses from the common electrical bus.

In other aspects of the disclosure one or more of the following features may be included, specifically they are applicable to the method of receiving fault managed power in the previous paragraph and each of the features may be combined with any other feature listed. The method may include connecting a converter device to the at least one switch to output a required form of power to the electric grid and integrating the converter device and the FMP receiver into a gateway module. The processing circuity includes a digital signal processor. The method may include controlling the at least one switch to receive the FMP output pulses transmitted by the at least two FMP transmitters during power transfer periods and controlling the at least one switch to disconnect from the common power bus when the at least two FMP transmitters cease transmission of ceasing transmission of FMP output pulses during sample periods between power transfer periods. The method may include monitoring by the FMP receiver the common electrical bus for faults during sample periods and, if a fault is detected, sending a signal to the at least two FMP transmitters to terminate transmission of FMP output pulses to the common electrical bus. The first electrical power source may be one or more of a solar power source, a battery power source, and a generator power source. The first electrical power source may include a battery power source and wherein the battery power source is rechargeable. The method may include receiving via the converter device power from the electric grid in the required form of power for the electric grid and outputting converted power from the converter device; the method may further include controlling the at least one switch to receive the converted power and to transmit by the FMP receiver FMP output pulses over the common electrical bus; wherein the step of controlling may include receiving an external timing trigger to enable the FMP receiver to synchronize the transmission of the FMP output pulses with the transmission of FMP output pulses from the plurality of power module devices. The method may include operating the FMP receiver as a master and synchronizing transmission of the FMP output pulses from the at least two transmitters using a master-slave process. The method may include operating the FMP receiver as a slave and receiving the external timing trigger from one two FMP transmitters operating as a master. The method may include receiving by the FMP receiver the external timing trigger from one of i) one of at least two FMP transmitters, or ii) a management device. The method may include modulating the external trigger timing signal on the FMP pulses by one of the at least two FMP transmitters. The method may include outputting current by the FMP receiver based on one or more of an impedance of the common electrical bus and a voltage at the output of the at least two FMP transmitters. The method may include adjusting a voltage of the FMP output pulses transmitted by the FMP receiver based on a state of charge of a power source including a rechargeable battery. The method may include causing the FMP receiver to selectively apply a predetermined bias voltage during sample periods. The method may include detecting by the FMP receiver a fault based on a predetermined aggregate bias applied by one or more of the at least two FMP transmitters and the FMP receiver during a sample period. The method may include connecting a first capacitor between the output of the at least one switch and the converter device and receiving the FMP output pulses by the capacitor and outputting DC power to the converter device. The method may include connecting a second capacitor between the output of the at least one switch and the converter device to receive the required form of power from the electric grid and output DC power to the at least one switch.

These and other features of the invention will be apparent from the following detailed description and the accompanying figures.

### BRIEF DESCRIPTION OF THE DRAWINGS

The foregoing features of embodiments will be more readily understood by reference to the following detailed description, taken with reference to the accompanying drawings, in which:

FIG. 1 is a block diagram of a fault managed power (FMP) electricity system.

FIG. 2 is an illustration of a FMP voltage waveform.

FIG. 3 is a block diagram of an example of a FMP transmitter suitable for use in the FMP power system of this disclosure.

FIG. 4 is a block diagram of an example of a FMP receiver suitable for use in in the FMP power system of this disclosure.

FIG. 5 is a block diagram of an example of a FMP electric power system according an aspect of this disclosure.

FIG. 6 is a block diagram of another example of a FMP electric power system according an aspect of this disclosure.

FIG. 7 is a block diagram of yet another example of a FMP electric power system according an aspect of this disclosure.

FIG. 8A is an example of individual power module FMP output pulse streams output on a common power bus and an aggregate FMP pulse stream on the common bus.

FIG. 8B is another example of individual power module FMP output pulse streams output on a common power bus and an aggregate FMP pulse stream on the common bus with an external trigger or timing signal superimposed on the pulses.

FIG. 9A is a flow chart describing an example method synchronization of FMP output pulses on the common power bus and fault detection on the common power bus.

FIG. 9B is a flow chart describing another example method synchronization of FMP output pulses on the common power bus and fault detection on the common power bus.

FIG. 10 is a flow chart describing yet another example method synchronization of FMP output pulses on the common power bus and fault detection on the common power bus.

FIG. 11 is schematic diagram of an example of a FMP power module device according to an aspect of this disclosure.

FIG. 12 is schematic diagram of an example of a FMP gateway module according to an aspect of this disclosure.

FIG. 13 is a flow chart describing a device discovery protocol according to an aspect of this disclosure.

FIG. 14 is a solar insolation curve.

FIG. 15 is a voltage/current output profile for the common power bus according to this disclosure.

FIG. 16 is a common bus output voltage as a function of the state of charge of a battery based electrical power source according to this disclosure.

FIG. 17 is a back-to-back FET arrangement for use as a switching device according to an aspect of this disclosure.

FIG. 18 depicts waveforms using different bias usage, inline communications and examples of line fault presentations on the common power bus.

### DETAILED DESCRIPTION OF SPECIFIC EMBODIMENTS

The disclosure and the various features and advantageous details thereof are explained more fully with reference to the non-limiting embodiments and examples that are described and/or illustrated in the accompanying drawings and detailed in the following description. Various aspects of the subject matter discussed in greater detail below may be implemented in any of numerous ways, as the subject matter is not limited to any particular manner of implementation. Examples of specific implementations and applications are provided primarily for illustrative purposes.
Unless otherwise defined, used, or characterized herein, terms that are used (including technical and scientific terms) are to be interpreted as having a meaning that is consistent with their accepted meaning in the context of the relevant art and are not to be interpreted in an idealized or overly formal sense unless expressly so defined herein. The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms “includes,” “including,” “comprises,” and “comprising” specify the presence of the stated elements or steps but does not preclude the presence or additional of one or more other elements or steps.

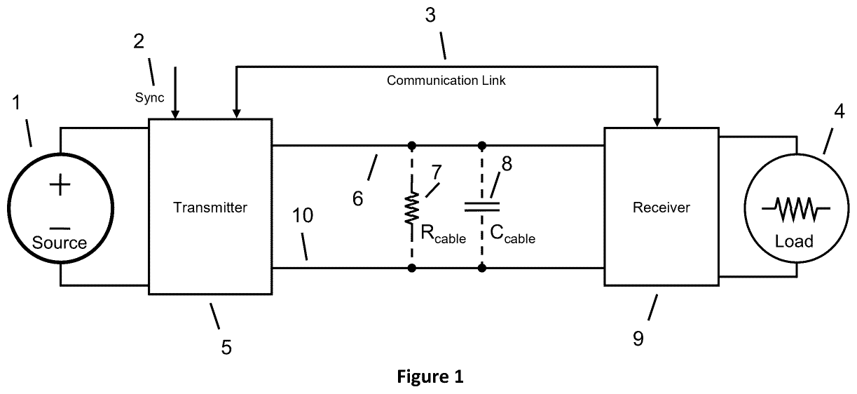

This disclosure in general relates to systems using fault managed power (FMP) to more safely deliver power from multiple power sources to a relatively high voltage common electrical bus and further to systems with power sources having electric storage devices configured to receive FMP from the common bus to charge such electric storage devices. Fault Managed Power (FMP) is defined in the 2023 US National Electrical Code, and includes all modes of power distribution where power is delivered in a sequence of high voltage DC pulses, where the transmission line is characterized in some way between each pulse or for each pulse. In general, a line fault will be detected within one or two pulse intervals and the power safely disconnected prior to causing an injury or fire. Therefore, it may be referred to as “touch safe”.
In this disclosure there is described a system that combines power sources such as solar panels, and/or distributed energy storage, and any other type of electric power sources, utilizing FMP transmitters, also referred to as Pulse Mode Power transmitters or Digital Electricity transmitters, to deliver FMP power to a shared or common power bus. From the common bus, the aggregated FMP power may be received by one or more FMP receiver(s) to convert the DC pulses to DC power and then, for example, using an inverter/converter, the DC power may be converted to AC power for connection to a power grid or higher voltage DC power for connection to a microgrid. Conversion to DC power and input to an inverter for producing AC power is not a requirement of this disclosure, as any other suitable way of converting the DC pulses to AC power or another DC power form are within the scope of this disclosure.
Using FMP power in the power system of this disclosure, provides a touch safe and fire safe power system that ensures the common power bus may not be overdriven with an unsafe amount of current or voltage, that the transmission of power is immediately interrupted when a line fault across the power bus or from the hot side of the power bus to ground is detected, and that power delivery is disabled in the event of a non-islanded grid outage or as requested by a safety power off switch along the bus or at a power receiver. A non-islanded grid outage is an outage where the power system is not disconnected from the power grid in the event of a grid outage.
To aggregate FMP power from multiple FMP transmitters, pulse synchronization across the power transmitters must be implemented to ensure that all the power transmitters drive the common bus at identical times and utilize the same timing window for parallel detection of power bus fault conditions, for example, crossline faults and/or ground faults. The system of this disclosure may utilize any suitable FMP transmitter/receiver provided by various manufacturers; however, one manufacturer's FMP transmitter/receiver technology (Voltserver, Inc.) is described in more detail only to provide context for the systems described herein and to provide a better understanding of how FMP systems operate.
Voltserver's FMP technology uses electrical power distributed in discrete, controllable units of energy, also referred to as packet energy transfer (PET) as disclosed in U.S. Pat. Nos. 8,068,937, 8,781,637 and international patent application PCT/US 2017/016870, filed 7 Feb. 2017 (each incorporated by reference herein and together referred to as Eaves 2012). Packet energy transfer or PET is a type of fault managed power and may be used in the FMP devices, systems, and methods described and claimed herein. However, this disclosure is not limited to PET devices, systems, and methods and is applicable to any other type of FMP.
As described in Eaves 2012, a source controller and a load controller are connected by power transmission lines. The source controller of Eaves 2012 periodically isolates (disconnects) the power transmission lines from the power source and analyzes, at a minimum, the voltage characteristics present at the source controller terminals directly before and after the lines are isolated. The time period when the power lines are isolated was referred to by Eaves 2012 as the “sample period”, and the time period when the source is connected is referred to as the “transfer period”. The rate of rise and decay of the voltage on the lines before, during and after the sample period reveals if a fault condition is present on the power transmission lines. Measurable faults include, but are not limited to, short circuits, high line resistance or the presence of an individual who has improperly contacted the line.
Eaves 2012 also describes digital information that may be sent between the source and load controllers over power transmission lines to further enhance safety or provide general characteristics of the energy transfer, such as total energy or the voltage at the load controller terminals. One method for communications on the same digital power transmission lines as used for power was further described and refined in U.S. Pat. No. 9,184,795 (Eaves Communication Patent). One application of a digital power distribution system is to safely distribute direct-current (DC) power in digital format and at elevated voltage from the source side of the system to the load side. U.S. Pat. No. 9,853,689 (Eaves Power Elements) describes the packaging of the source side components of Eaves 2012, in various configurations, into a device referred to as a digital power transmitter.
U.S. Pat. No. 9,419,436 (Eaves Receiver Patent) describes the packaging of various configurations of the load side components of Eaves 2012 into a device referred to as a digital power receiver, including several power conditioning circuit embodiments such as DC/DC conversion and DC/AC inversion. U.S. Pat. No. 9,893,521, “Digital Power Network Method and Apparatus”, hereafter referred to as “Lowe 2014”, introduced the concept of multiple sources of power and multiple loads connected safely in a digital power network using Packet Energy Transfer. The concept of a power control element (PCE) was introduced in Lowe 2014 as a primary component in a digital power network. U.S. patent application Ser. No. 15/963,582 (Mlyniec 2017) describes methods for verifying digital electricity line integrity, which includes applying a bias to the transmission line during the sample period, synchronizing the start times of respective sample periods on first and second transmission lines, among other methods. U.S. Pat. No. 10,714,930 (Weiss 2018) describes the usage of carrier wave detection to measure the impedance of a transmission line in a power-distribution system.
A simplified diagram of a FMP system, as originally described in Eaves 2012 and further expanded upon in Mlyniec 2017 is shown in FIG. 1. The system performs the PET protocol when the power transmission lines 6 and 10 are periodically isolated from source 1 and load 4 via action of transmitter 5 and receiver 9. During this period of isolation, referred to as the sample period, the transmitter 5 performs measurements to verify the integrity of the transmission line to determine if energy transfer from the transmitter output should resume. As discussed in Eaves 2012, the rate of decay of the energy stored on the transmission lines can be observed and indicates whether there is a cross-line fault present on the transmission lines. The inherent line-to-line impedance of the transmission line is represented with resistance (R_{cable}) 7 and capacitor (C_{cable}) 8. From the perspective of the transmitter 5, this line-to-line, or cross-line, impedance also includes the cross-line impedance of the transmitter front-end and receiver front-end circuitry, referred to as the effective cross-line impedance.

### FMP Transmitter

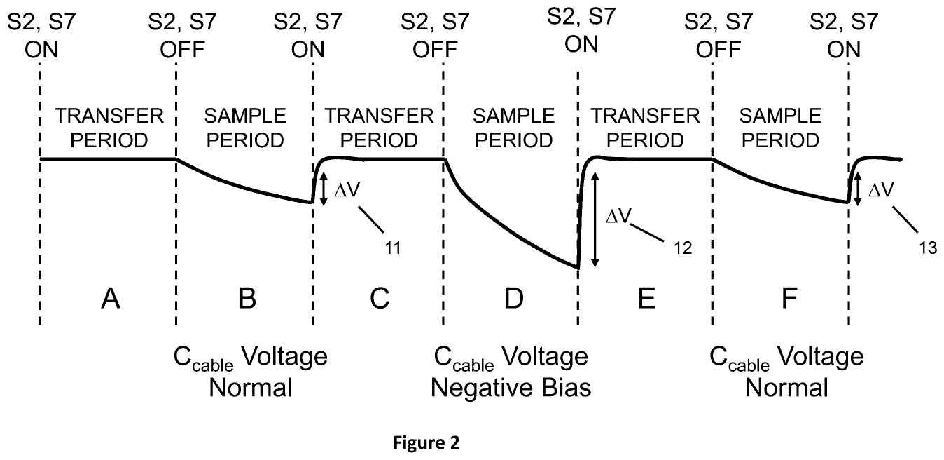

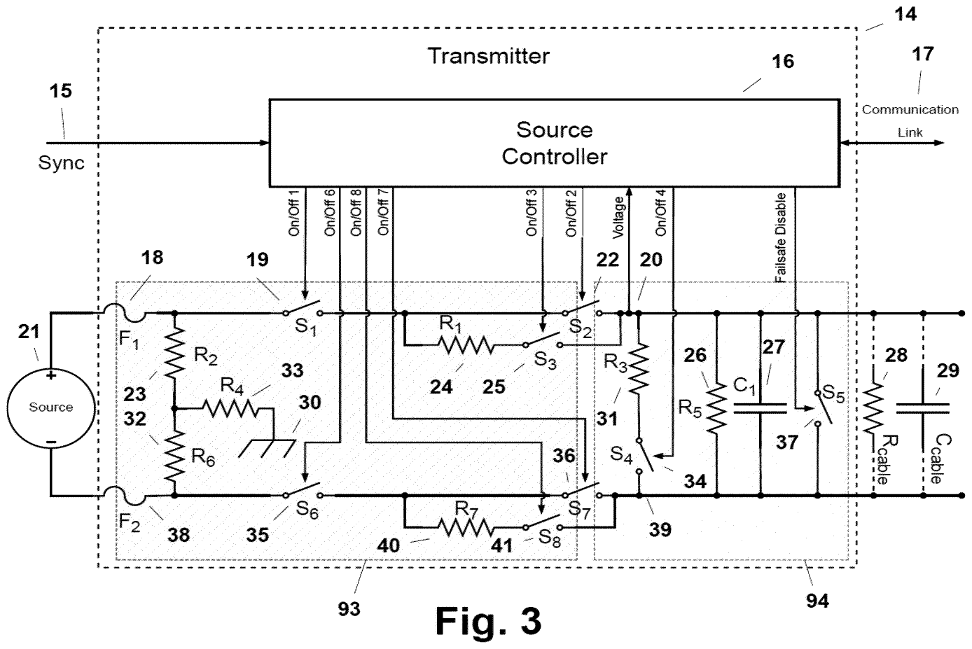

FIG. 2 shows an example waveform of steady-state system operation of a FMP or PET system, according to aspects of this disclosure. During transfer periods A, C, and E, switches (S₂) 22 and (S₇) 36 of FMP transmitter 14, FIG. 3, are closed (set to a low-impedance state) and energy flows from source 21, through the transmission lines, to any connected receivers and their attached loads (not shown). FMP Transmitter 14 is described only as an example to provide context and understanding of how FMP systems operate and how they may be configured. FMP transmitter 14 is described further in co-pending published patent application no. US 2025/0149964, which is incorporated herein in its entirety. This disclosure and the embodiments covered by the claims herein are not limited to FMP transmitter 14 and any suitable FMP transmitter is intended to be applicable to the FMP power systems disclosed and covered herein.

During sample periods B, D, and F, transmitter switches (S₂) 22 and (S₇) 36 are opened (set to a high-impedance state). Similarly, any connected receivers isolate their attached loads either passively (via reverse blocking action of diodes) or actively (via an electrically controlled switch such as a FET, BJT, etc.) from the transmission line. The transmitter source controller 16 may be configured to perform one or more of the PET protocol methods taught in Eaves 2012 and Mlyniec 2017 to determine whether a fault is present.

During sample periods, a voltage bias may or may not be applied by the transmitter. For example, as shown in FIG. 2, during sample periods B and F no bias is applied by transmitter 14, allowing the energy stored in the transmission line capacitance 29, transmitter capacitance 27 and any connected receiver capacitance to decay at a rate inversely proportional to the aggregate values of the cross-line resistance of the transmission lines, (R_{cable}) 28 and resistor (R₅) 26 within the transmitter 14. On the other hand, during sample period D the transmitter applies a negative bias by closing switch (S₄) 34, allowing the stored energy to decay at a rate inversely proportional to the aggregate values of the inherent cross-line resistance of the transmission lines (R_{cable}) 28 and resistors (R₅) 26 and (R₃) 31 within the transmitter 14. With or without a bias, if the associated pre-determined limits (according to the applicable PET protocol) have not been exceeded (i.e. no fault was detected), at the end of each sample period, switches (S₂) 22 and (S₇) 36 are closed, allowing energy from the source 21 to flow through the transmission lines, to ultimately deliver energy to the attached loads on any connected receivers during each transfer period.

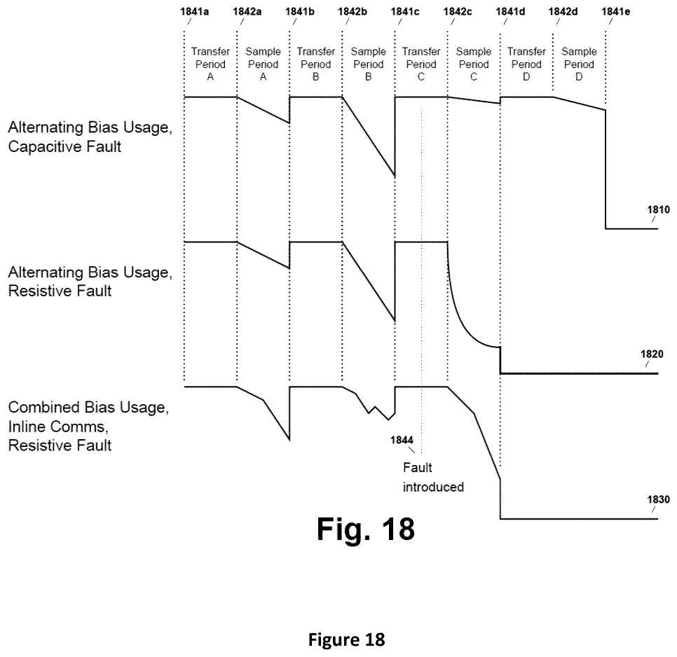

FIG. 18 shows different arrangements of bias usage and inline communications as well as examples of line fault presentations on the power bus. Three configurations are shown as waveform 1810, waveform 1820, and waveform 1830. Each configuration is shown with a sequence of alternating transfer periods and sample periods A-D, wherein each transfer period is initiated (or would be initiated) by a FMP transmitter at time 1841a, 1841b, 1841c, 1841d, 1841e and each sample period is initiated by a FMP transmitter at time 1842a, 1842b, 1842c, and 1842d. In all configurations, a fault is inserted at time 1844.

In waveform 1810, a bias is applied in alternating sample periods as shown in sample period B and sample period D, wherein this bias is a negative bias such as a pulldown resistance. When a high line-to-line capacitance is connected at time 1844, the effect is observed in the next sample period C. In this example, high capacitance faults are only detected during sample periods with a bias, so transfer period D is permitted. Upon reaching sample period D, due to the voltage decay being smaller than expected, a high capacitance fault is detected and power transmission ceases.

In waveform 1820, the bias usage is the same as 1810, but in this example a low line-to-line resistance is connected at time 1844. This effect is observed in sample period C, and with the voltage decay being larger than expected, a low resistance fault is detected and power transmission ceases.

In waveform 1830, each sample period includes at least a time interval without a known bias connected and a time interval with a known bias connected. Additionally, there may be a time interval allocated for inline communications as shown in sample period B. When a low line-to-line resistance fault is connected at time 1844, a low resistance fault is detected and power transmission ceases, wherein this detection could be based upon the comparison of the voltage decay against a limit or it could be based upon calculating the effective line-to-line resistance and/or the effective line-to-line capacitance from the measurements with and without the bias applied and comparing the resistance and/or the capacitance against a limit (in this case, the comparison calculation and the comparison must include at least the effective line-to-line resistance).

Inherent in the PET waveform is an easily measurable voltage change, ΔV, for example 0.6 volts, that occurs in a short time frame during the transition between sample period and transfer period at points 11, 12, and 13, FIG. 2. This occurs when the transmitter closes the internal switches and charges the effective cross-line impedance of the system back to the voltage of source 21. This large rate of change with respect to time is also referred to as a high dV/dt event and it indicates the start of each transfer period.

With prior art PET systems, the PET protocol cannot begin until the transmission line and a receiver are connected to the PET transmitter, because there is not a sufficient level of cross-line capacitance in the transmitter and the transmission line to allow the PET protocol to operate properly. A prior art receiver having a discrete capacitor in its front-end circuit would be connected to the transmission line to provide a sufficient amount of aggregate capacitance to run the PET protocol. However, with transmitter 14, FIG. 3, there is included a capacitor (C₁) 27 that adds additional cross-line impedance not present in prior art PET transmitters. The addition of capacitor (C₁) 27 allows the transmitter to begin the PET protocol before any receiver or transmission line is connected to transmitter 14. This is possible because capacitor (C₁) 27 provides a sufficient amount of cross-line capacitance at the output of the transmitter to allow the PET protocol to run. It should be noted that capacitor (C₁) 27 may or may not dominate the inherent capacitance on the transmission line or receiver front-end capacitance.

Transmitter 14 may further include a bias circuit to help verify transmission line integrity as shown in and described with respect to FIG. 2, sample period D. The combination of resistor (R₃) 31 and switch (S₄) 34 is a particular embodiment of a bias circuit. This bias circuit can also be used to perform in-line communications between the transmitter 14 and any connected receivers, as taught in the Eaves Communication Patent. Communication may also take place over a separate copper or fiber optic connection via Communication Link 17. Additionally, Mlyniec 2017 discusses the use of an external sync signal 15 for improved line measurement integrity.

Transmitter 14 may additionally include switches (S₁) 19 and (S₆) 35 to provide secondary protection in the event of a single component failure in transmitter 14. Under normal operating conditions switches (S₁) 19 and (S₆) 35 are left closed. In the event of multiple component failures, protection is provided via fuses (F₁) 18 and (F₂) 38 and the failsafe switch (S₅) 37, forming a crowbar circuit. There may be included a soft start circuit comprising switch (S₃) 25, resistor (R₁) 24, switch (S₈) 41 and resistor (R₇) 40 which enables current-limited soft start functionality (i.e. the transmitter soft-start process). This soft start circuit charges the capacitive portion of the effective cross-line impedance of the system and the start-up input impedance (described below) of any connected receiver(s), protecting the transmitter circuitry from the large current spike that would occur otherwise when the transmitter first applies power to the transmission lines. Additionally, current limited earth ground 30 balance is provided via balance resistors (R₂) 23, (R₆) 32, and current-limiting resistor (R₄) 33.

In some alternative embodiments, some transmitter switches may be omitted. Instead of opening both switches (S₂) 22 and (S₇) 36 for the sample period, it is possible to open only one of those switches. This is not optimal as far as robust performance, but it may be sufficient in cost-sensitive applications. Similarly, instead of the soft-start circuit comprising switch (S₃) 25, resistor (R₁) 24, switch (S₈) 41 and resistor (R₇) 40, it could omit switch (S₈) 41 and resistor (R₇) 40 in favor of using switch (S₇) 36, or omit switch (S₃) 25 and resistor (R₁) 24 in favor of using switch (S₂) 22.

Components within box 93 may be considered the input conditioning and protection circuitry. These components add secondary protection to the system and condition the power from the source. Components within box 94 may be referred to as the PET front-end of the transmitter. These components are directly connected across the transmission line and directly measure or modify the properties of the transmission line. Switches (S₂) 22, (S₃) 25, (S₇) 36 and (S₈) 41 delineate the boundary between these two subsections of the transmitter circuitry.

### FMP Receiver

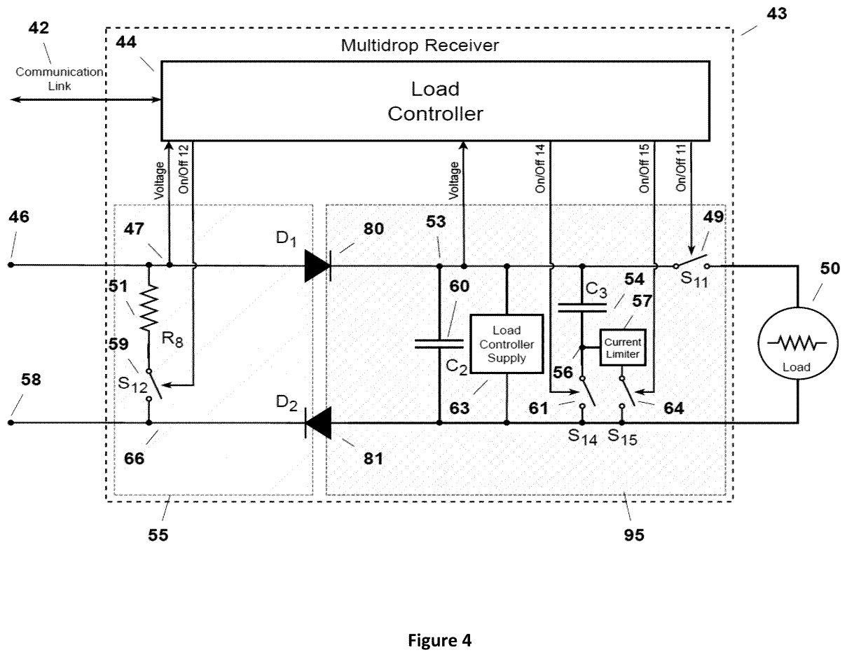

FIG. 4 shows a detailed block diagram of an example FMP receiver (receiver 43), which may be used in the FMP systems of this disclosure. FMP receiver 43 is also described further in co-pending published patent application no. US 2025/0149964, and is described only as an example to provide context and understanding of how FMP systems operate and how they may be configured. This disclosure and the embodiments covered by the claims herein are not limited to FMP Receiver 43 and any suitable FMP receiver is intended to be applicable to the FMP power systems disclosed and covered herein. Moreover, while receiver 43 shown in FIG. 4, is configured for a multi-drop PET system, this is not a requirement for a FMP receiver according to this disclosure and any suitable FMP receiver may be used. A multi-drop receiver is one with a very high front-end impedance and high start-up input impedance allowing multiple receivers to be connected to a common transmission line without drawing, in the aggregate, an amount of current/power that would trip the line characterization safety detection of the PET transmitter.

In receiver 43, the front-end impedance is the aggregate impedance of the components of front-end circuits 55. The start-up input impedance of each receiver further includes the impedance of the additional components beyond the front-end circuit 55 up to and including the load controller supply 63 in the output control and conditioning circuitry 95. Switches may be selectively opened and closed to remove various components (i.e. the load controller supply 63) which contribute to the start-up input impedance from the circuit during sample periods (further described below). Therefore, in certain cases, the start-up input impedance may be equal to the front-end impedance. The front-end impedance is the impedance that is seen by the transmitter during normal operation of receivers 43, i.e. after the receiver start-up process. The start-up impedance is the impedance seen by the transmitter during the start-up process.

Points 46 and 58 represent the receiver inputs, which connect to the power transmission lines. Components within box 55 are considered PET front-end receiver circuitry and components within box 95 are considered output control and conditioning circuitry. These two sections of the receiver are delineated by diodes (D₁) 80 and (D₂) 81 as shown in FIG. 4, Components attached to the PET front-end directly measure or impact transmission line characteristics. For example, load controller 44 may perform various measurements on the transmission lines during operation.

Components residing in the output control and conditioning circuit 95 perform various functions. Capacitor (C₂) 60, referred to as the bootstrap capacitor, supplies capacitance just after the diodes or switches to allow the receiver to operate. Capacitor (C₂) 60 maintains the voltage across the load controller supply 63 (described below) during sample periods. Capacitor (C₂) 60 serves an additional purpose: to keep diodes (D₁) 80 and (D₂) 81 reverse biased (i.e. open) during sample periods. Capacitor (C₂) 60 may be sized with the minimum amount of capacitance needed to maintain the required minimum voltage across the load controller supply 63 during sample periods and, in the case of receiver 43 shown in FIG. 4, to keep diodes (D₁) 80 and (D₂) 81 reverse biased during sample periods.

If the RC time constant formed by capacitor (C₂) 60 and the effective resistance of the load controller supply 63 is less than the RC time constant of the effective transmission line impedance, then capacitor (C₂) 60 may potentially discharge to a point where diodes (D₁) 80 and (D₂) 81 are no longer reverse biased during the sample period. In a simpler implementation, a single diode on the positive leg of the circuit may be used, e.g. just diode (D₁) 80.

Also, in output control and conditioning circuit 95 is capacitor (C₃) 54 referred to as the receiver bulk capacitance. This capacitor acts as local bulk energy storage for the load 50 when the receiver diodes/switches are reverse biased/open. This capacitor is charged during the receiver initialization sequence when the load controller 44 closes switch (S₁₅) 64. Bulk capacitor (C₃) 54 may be sized based on the maximum desired load current and maximum allowable output voltage ripple.

The peak current is limited via current limiter 57. Switch (S₁₄) 61 bypasses the current limiter 57 allowing capacitor (C₃) 54 to be directly connected across the output of the receiver. Switch (S₁₁) 49 allows the load controller 44 to have control over when power is delivered to load 50. The current limiter 57 and switch (S₁₅) 64 may be eliminated entirely if the load controller 44 implements a Pulse-Width Modulation method to control Switch (S₁₄) 61 to limit the average and peak currents. The current limiter 57 and switch (S₁₅) 64 may also be eliminated if the load controller 44 operates switch (S₁₄) 61 in the resistive region to limit the current, possibly in combination with the usage of Pulse-Width Modulation.

Before powering the connected load 50, charging of bulk capacitor (C₃) 54 begins and continues until the bulk capacitor is fully charged. The load controller 44 closes switch (S₁₅) 64 and current limiter 57 limits the peak current. Voltage across bulk capacitor (C₃) 54 is measured across points 53 and 56 and once the voltage across capacitor (C₃) 54 reaches a predetermined threshold, the load controller closes switch (S₁₄) 61, directly connecting bulk capacitor (C₃) 54 across the output so that bulk capacitor (C₃) 54 acts as local bulk energy storage.

In normal operation, after start-up, and during power transfer periods, diodes 80 and 81 are forward biased and allow current flow through PET front-end 55 and into output control and conditioning circuit 95 to directly supply the load 50. During sample periods, when diodes 80 and 81 are reverse biased and block current flow through PET front-end 55 and into output control and conditioning circuit 95, capacitor (C₃) 54 supplies energy to the load 50, wherein an optimal diode used for this purpose features a fast reverse recovery specification to achieve this current flow blocking with minimal delay, and wherein a fast soft reverse recovery diode can provide a tradeoff of a slightly slower response but with improved electromagnetic compatibility (EMC). The load controller 44 continuously monitors for output faults, until input power is lost.

Also during normal operation, while initially charging capacitor (C₃) 54, switch (S₁₅) 64 needs to be switched synchronously with the PET waveform, i.e. closed during the transfer period and opened during the sample period. For instance, if switch (S₁₅) 64 is closed during the sample period, capacitor (C₂) 60 may discharge to a point which causes the load controller supply 63 to turn off. Alternatively, the current limiter 57 could limit the current to avoid the excessive discharge of capacitor (C₂) 60, provided the increased charge time of capacitor (C₃) 54 is acceptable. Resistor (R₈) 51 and switch (S₁₂) 59 are a particular embodiment of a bias circuit and may be used to allow the receiver to participate in inline communications. Communication may also occur via communication link 42 over a separate copper or fiber optic connection.

### FMP Systems

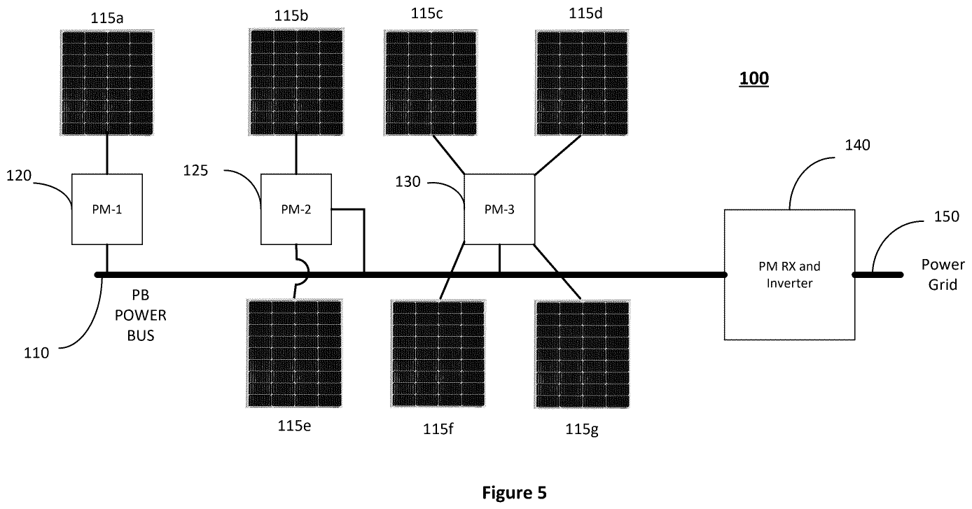

One embodiment of the power delivery system using a common bus of this disclosure is depicted in FIG. 5. With this embodiment, individual solar panels with shared power electronics, drive a common power bus in a parallel configuration. In this embodiment, one to four solar panels share a common power module that includes a FMP transmitter to output FMP pulses onto the common power bus. This embodiment is preferred in that the power electronics for each panel or cluster of panels is only required to handle the power requirements for the panels it is directly interfaced to, and not for the entire string of panels, as is the case with prior art solar panel systems. Also, the number of conductors is minimized.

Many variations are possible including a plurality of power sources connected to a single power module or a single power source connected to a plurality of power modules, wherein each power module is connected either to the same power bus or to distinct power buses. In the case where a single power source and a single power bus have a much higher power output and power capacity than an individual power module, a plurality of power modules can be connected in parallel between the single power source and the single power bus to split the power to avoid exceeding the rating of any individual power module.

Typically, only two or three conductors are required in the shared bus, a “hot” conductor, a “common” conductor, and ground, as required by local and national electrical codes. However, additional pairs can be used, wherein each additional pair essentially forms a parallel power bus. This can be advantageous to overcome the increased power losses and voltage drop on the power bus conductors as current increases, as well as offer the possibility of redundancy. These parallel power buses can be combined in any number of ways known in the art, including the methods disclosed Eaves U.S. Pat. No. 9,419,436.

Referring to FIG. 5, there is shown power delivery system 100 which includes a common DC power bus 110 to carry the power output from seven (7) solar panels 115a-115g. The solar panels 115a-115g and bus 110 may be mounted on a rooftop and, for example, may have a 10 KW output operating at 340 volts peak voltage. Common power bus 110 may be a single power bus rated for transmission of 30 Amperes of current. The power output/number of panels and the size of the DC bus will be application specific and depend on the voltage and current carrying capacity that is required for the particular application.

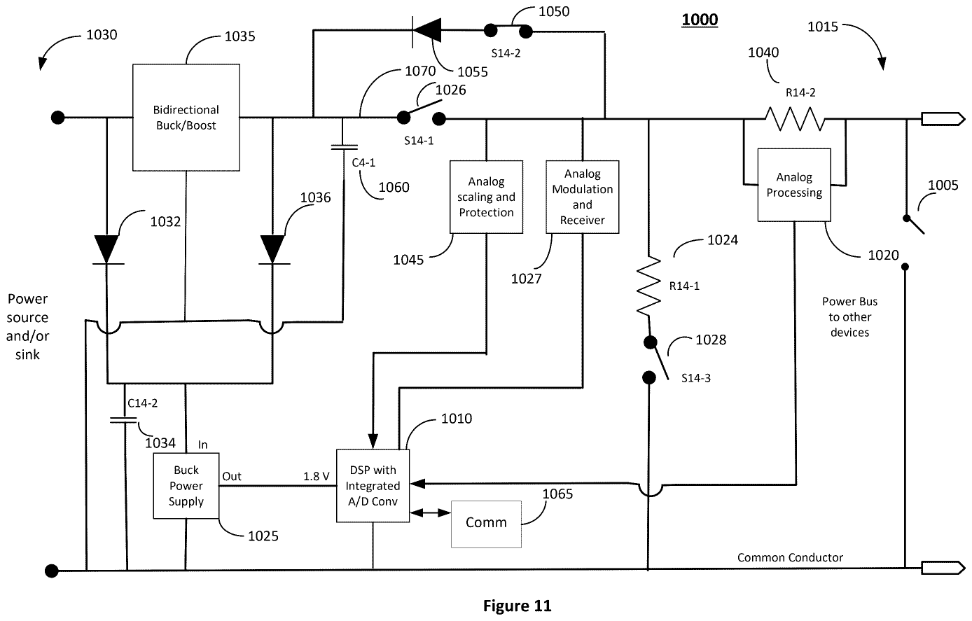

Common power bus 110 may be driven in parallel by multiple power modules. In this example it is driven by three power modules 120, 125, and 130, which each contain a FMP transmitter. The FMP transmitter may be configured like the FMP transmitter of FIG. 3, or it may be configured in another suitable way, as is known in the art. A block diagram of a typical power module, according to an aspect of this disclosure is depicted in FIG. 11 and described below. As shown in FIG. 5, power module 120 may be connected at its power source input to solar panel set 115a and receive the solar panel DC output. The output of power module 120 is connected to common power bus 110 and will produce and transmit FMP output pulses at a desired voltage level, in the example described above, the pulses will be approximately 340V.

Power module 125 may be connected at its power source input to solar panel sets 115b and 115e and receive their DC outputs. The output of power module 125 is connected to common power bus 110 and it will produce and transmit FMP output pulses at the desired voltage level. Finally, power module 130 may be connected at its power source input to solar panel sets 115c, 115d, 115f and 115g and receive their DC outputs. The output of power module 130 is also connected to common power bus 110 and it will produce and transmit FMP output pulses at the desired voltage level.

The power modules are configured to upconvert the typical <50 volt output from each solar panel set to between 300 volts and 450 volts and modulate this voltage into approximately millisecond long pulses to deliver FMP power on common power bus 110. Also connected to common power bus 110 via its input may be a gateway module 140 having an output that may be inverted into an electrical format for attachment to electric grid 150. This is typically an AC voltage and in the range of 110 volts to 480 volts single phase or three phase for a solar panel system, but the output of the gateway module 140 may take any format required for the electric grid, including both AC and DC at various voltage levels. It should be noted that the common bus 110 need not be connected to a gateway module for ultimate connection to an electric grid. It simply needs to be connected to a FMP receiver whose output may be connected to various types of loads.

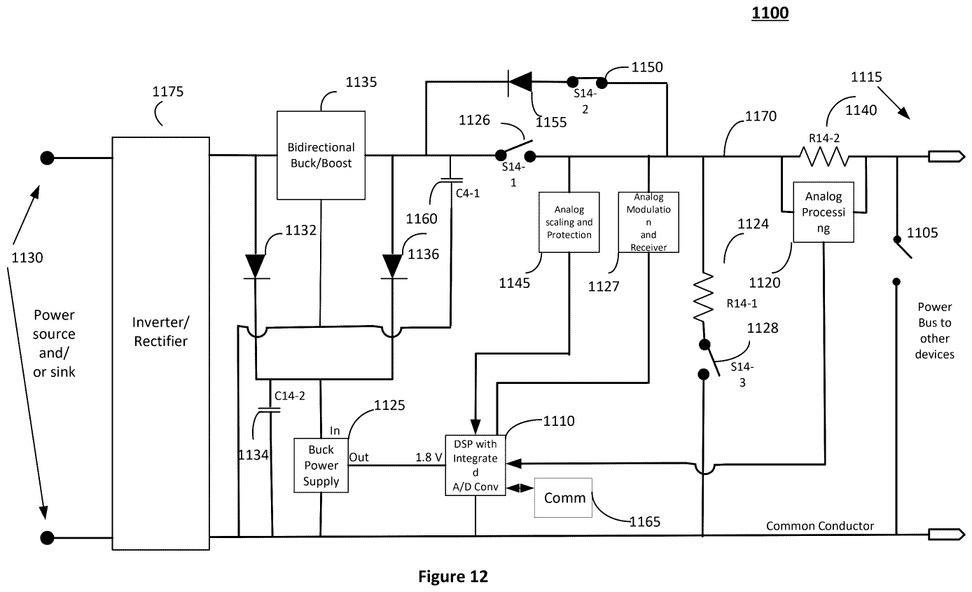

The gateway module 140 may include a FMP receiver which may be configured like the FMP receiver of FIG. 4, or it may be configured in another suitable way, as is known in the art. The gateway module 140 may also include an inverter to receive a DC voltage from the output of the FMP receiver and convert the DC voltage to AC. A block diagram of an exemplary gateway module, according to an aspect of this disclosure, is depicted in FIG. 12 and described below.

The electric grid 150 may comprise one or more of a microgrid, a utility distribution system, or a utility transmission system and the electrical format for attachment to electric grid 150 may be AC or DC and it may require even higher voltage levels than the output of the FMP receiver. For example, in some microgrid applications, the format may be DC with a voltage of up to 1,500 volts DC. In other applications, such as connection to a utility grid, the format may be AC and require thousands of volts. In any case requiring a higher AC voltage, the output of the gateway module may be provided to a step-up transformer (not shown) to increase the voltage to the level required for the electric grid 150.

For an increased DC voltage output, this may be achieved with a DC-DC converter (in place of the inverter) configured to increase the DC output voltage to the level required. The use of a separate inverter or a DC-DC converter is not a requirement of this disclosure and as these functions may be implemented in different ways, including integrating the features into the FMP receiver, such that the FMP output pulses may be rectified to a higher voltage DC or may be directly inverted from the FMP output pulses to AC.

Continuing to Refer to FIG. 5, the parallel connected power modules 120, 125, and 130, are fed DC power by solar panel sets 115a-115g. Each power module contains a FMP transmitter, to drive common power bus 110 with FMP output pulses at a desired voltage level in a synchronized manner to deliver their maximum aggregate power onto common bus 110. In addition to ensuring the maximum aggregate power of the power modules is transferred to common bus 110, the FMP transmitters must all be synchronized to transmit at the same time such that their active pulses fully overlap in the power transfer period of the FMP system.

This synchronization ensures that the high impedance FMP sample periods (between power transfer periods) are all aligned in time across the FMP transmitters sharing the common power bus 110. This makes it possible to accurately detect faults during the sample periods. If the FMP pulses are not synchronized, the sample periods will be contaminated with voltages from one or more out of synch FMP output pulses making it impossible to detect faults caused by human contact or otherwise. While not required, typically all power modules will also be configured to detect faults and to terminate producing FMP output pulses to common power bus 110. In addition, gateway module 140 may be configured to detect line faults and transmit to the power modules a signal to terminate transmission of FMP output pulses.

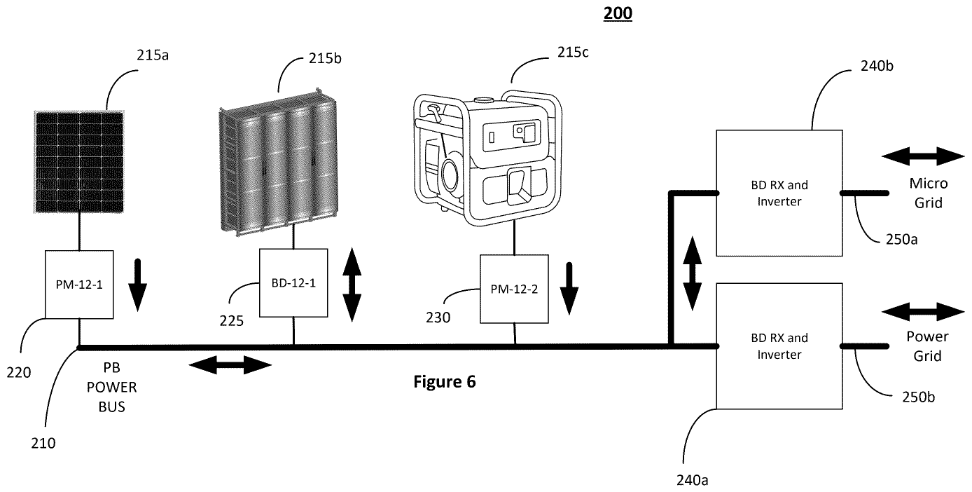

Before describing the transmitter synchronization process and the components and function of the power modules and gateway modules in more detail, power delivery systems according to different aspects of this disclosure are described. In FIG. 6 an exemplary power delivery system 200, combining solar panels, battery packs and a generator onto a bidirectional power bus with two external power sources and sinks, is shown. This system includes power source 215a, which is a set of solar panels; power source 215b, which is a battery pack; and power source 215c, which is a generator; wherein each power source outputs AC or DC power to power modules 220, 225, and 230, respectively.

Power modules 220, 225, and 230 convert the power source AC or DC power to FMP output pulses and deliver the pulses to common power bus 210. Also connected to common power bus 210 at its input may be a first gateway module 240a having an output that may be inverted into an electrical format for connection to electric grid 250. There is also a second gateway module 240b connected to common power bus 210 at its input and is connected to micro-grid 250b at its output. In this example, common power bus 210 is bi-directional, meaning that power from common power bus 210 may also be fed to a power source that is rechargeable, such as battery pack 215b.

Thus, power module 225 must also be bi-directional and include a FMP receiver to receive the FMP output pulses from the common power bus 210 and convert the pulses to DC power which may be fed to battery pack 215b for charging. When the power module 225 is receiving the FMP output pulses from the common power bus 210 it is not also transmitting FMP output pulses; however, power modules 220 and 230 may be outputting FMP pulses to common power bus 210. In addition, gateway modules 240a and/or 240b may also include FMP transmitters which may be outputting FMP output pulses to common power bus 210 when the battery pack is being charged or they may continue to deliver power to their respective electrical grids. Coordination of the power modules and gateway modules and their transitions between transmitting FMP output pulses and receiving FMP output pulses may be performed by a higher level control system. This is not described further herein as it is within the capabilities of someone skilled in the art and it is beyond the scope of this disclosure.

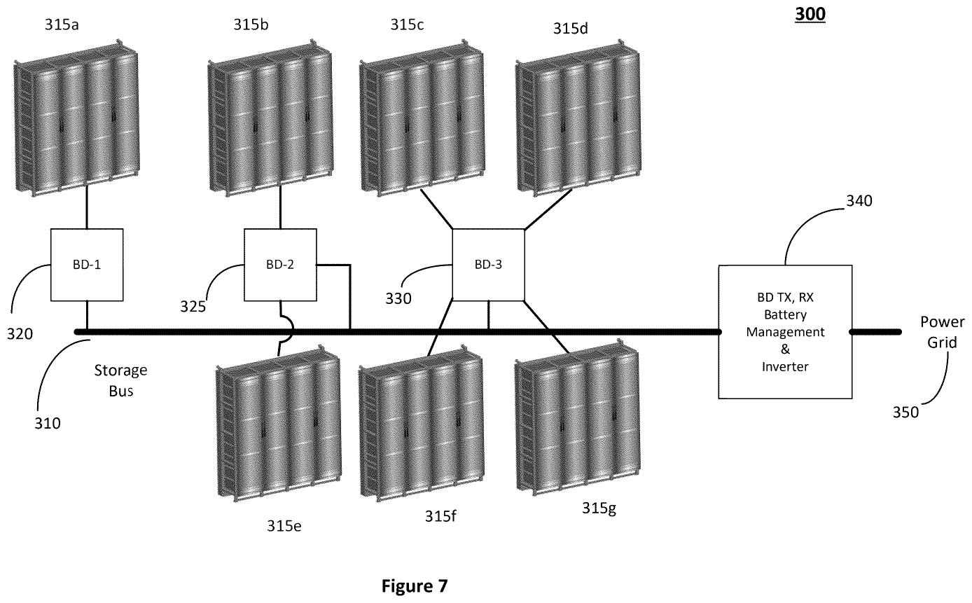

In FIG. 7, another exemplary power delivery system 300 has only battery pack power sources and a bidirectional power bus to enable charging and discharging of the battery packs. This system includes battery packs 315a-315g and power modules 320, 325, and 330. Power module 320 is connected at its input to battery pack 315a; power module 325 is connected at its input to battery packs 315b and 315e; and power module 330 is connected to battery packs 315c, 315d, 315f, and 315g. Power modules 320, 325, and 330 convert the power source DC power to FMP output pulses and deliver them to common power bus 310. Also connected to common power bus 310 at its input may be a gateway module 340 having an output that may be inverted into an electrical format for attachment to electric grid 350.

Common power bus 310 is bi-directional, such that power from common power bus 310 may be fed to each power source 315a-315g, and the common power bus 310 may be energized by power output from each power source. As a result, each of the power modules 320, 325, and 330 must also be bi-directional and include FMP receivers to receive the FMP output pulses from the common power bus 310 and convert them to DC power to be fed selectively to each of the battery packs 315a-315g for charging. When any power module is receiving the FMP output pulses from the common power bus 310 it is not also transmitting FMP output pulses; however, the other power modules may be outputting FMP pulses via their FMP transmitter to common power bus 310. In addition, gateway module 340 may also include an FMP transmitter which may be outputting FMP output pulses to common power bus 310 when one or more battery packs are being charged.

The examples of FIGS. 6 and 7 do not explicitly limit the quantity or type of power sources to provide power to the common power bus, nor loads deriving power from the common power bus. Moreover, power modules can be configured to meet desired goals with various parallel or fan-out/combiner options, such a power source connected to multiple power modules with each power module outputting to a separate power bus; a power source connected to a single power module that includes a plurality of FMP Transmitter PET front-ends, wherein the output of each switching element connects to a power bus distinct from the other power buses connected to said power module; a power source connected to a single power module that has a single output connected to a plurality of power buses; or any similar combination.

### FMP Transmitter Synchronization

As noted above, the FMP transmitters of the power modules must all be synchronized to transmit at the same time to a) ensure FMP output pulses are combined so that the aggregate power of the power modules is fully transferred to the common power bus, and b) to ensure that the pulses fully overlap in the power transfer period of the FMP system so that faults can be accurately detected in the sample periods.

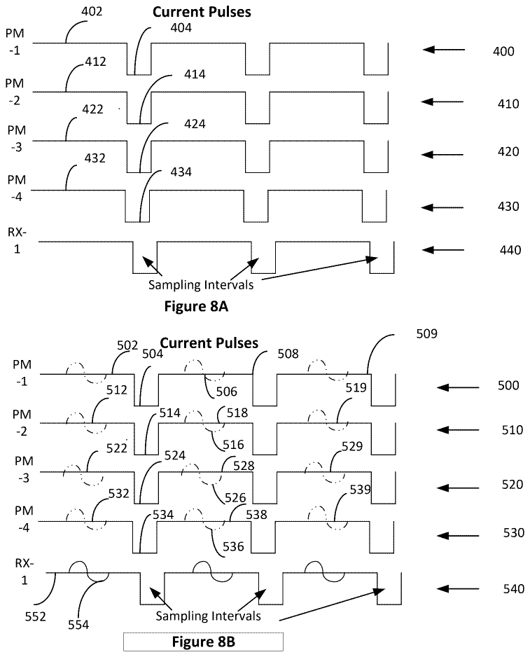

In FIG. 8A, FMP output pulse streams 400, 410, 420, and 430 from four (4) power module FMP transmitters show the pulses are fully overlapping when transmitted on the common power bus. In the first power transfer period, we can see output pulses 402, 412, 422, and 432 are aligned and their transitions from the power transfer period to the sample period occurs in synchronization when the FMP transmitters stop transmitting during sample periods. The sample periods 404, 414, 424, and 434, are also aligned. The aggregate FMP pulse stream 440 is received by FMP receiver in, for example, a gateway module 140 shown in FIG. 5.

In the embodiment exemplified by FIG. 8A, the power transmitters all evaluate the voltage waveform on the shared bus during their common “off” interval, i.e. during the sample period, as all sample periods are aligned. If it is determined that there is a fault, the FMP transmitters terminate transmission of FMP output pulses. Each transmitter may independently make its own fault decisions, so one or more may turn off and others may remain on if the situation is at the margins. Alternatively, one transmitter that detects a fault may trigger the others to the fault condition by turning on its crowbar circuit (described below with respect to FIGS. 11 and 12) to effectively short out the line. If no fault is detected by the FMP transmitters, they synchronously transmit a pulse during the next power transfer period In this example, one or more of the FMP transmitters are used to synchronize transmission of output pulses, using one of the methods described below.

Alternatively, the FMP receiver(s) may be configured to evaluate the voltage waveform during the common “Off” or sample period and, if no fault is detected, provide permission to the transmitters to transmit their next pulse synchronously. The FMP receiver may monitor the common power bus for faults, and may provide the FMP transmitters permission in the form of a timing pulse or RF signal imposed onto the bus at regular intervals. When the FMP transmitters receive the permission signal (also referred to herein as a timing trigger) they synchronously generate a FMP output pulse during the next transfer period. When the FMP receiver detects a fault condition, it stops delivering permission signals to the FMP transmitters and the FMP transmitters will in turn stop delivery of FMP output pulses. In an alternative embodiment, instead of the receiver providing the permission signal/timing trigger, the permission signal/timing trigger can be sent by the established transmitter timing master.

This is shown in FIG. 8B, where output pulse streams 500, 510, 520, and 530 from four (4) power module FMP transmitters are fully overlapping when transmitted on the common power bus. In the first power transfer period, output pulses 502, 512, 522, and 532 are aligned and their transitions from the power transfer period to the sample period occurs in synchronization when the FMP transmitters stop transmitting during sample periods 504, 514, 524, and 534, which are also aligned. The aggregate FMP pulse stream 540 is received by FMP receiver in, for example, a gateway module 140 in FIG. 5

The FMP receiver monitors each of the sample periods for a line fault, and if no fault is detected, transmits a permission signal for the next power transfer period. In this example, the permission signals/timing triggers are modulated on top of the driven region of the output pulse. For example, on aggregate output pulse 552 there is modulated sine wave 554 (shown as a solid one cycle sinewave) indicating that the FMP receiver did not detect a fault in the prior sample period (not shown). This is seen by each of the power transmitters as a dotted line single cycle sinewave, 506, 516, 526, and 536 on their next output pulses 508, 518, 528, and 538, indicating that they can transmit synchronously on the subsequent power transfer period, indicated by output pulses 509, 519, 529, and 539.

The approach described above with regard to FIG. 8B is just exemplary and the permission signal/timing trigger may be transmitted to the FMP transmitters via an RF signal, a digital pulse superimposed in the sample interval, or delivered over an out of band pathway such as RF through the air or using an additional conductor or fiber optic cable reserved for communications and timing, which may be within the same cable jacket as the power conductors or connected as a separate run. In these out of band embodiments, the permission signals/timing triggers may be generated and coordinated by a third device type that can be called a management device.

Turning to synchronization of output pulses by the FMP transmitters, in certain cases, one of the FMP transmitters in a FMP system may be designated as the timing “Master”, and other FMP transmitters therefore may be designated as the “Slaves”. In general, and particularly for reliability purposes, it is desirable that the FMP transmitters be configured to automatically resolve among themselves which FMP transmitter will be the timing master and provide output pulse timing for synchronization.

The determination of the timing master may be undertaken when the system is initially started and/or when the system is restarted, for example, following a system power down, a power failure, or a line fault. Once one FMP transmitter becomes the timing master, all other FMP transmitters may time their leading pulse edge and duration to closely match the master's pulse leading edge. The leading edge may be determined by monitoring current flows through a resistive shunt or magnetic sensor, or the leading edge may be detected by monitoring for the roughly 0.6 volt increase in voltage whenever sufficient current flows to enable forward diode conduction in the FMP receiver or receivers. Alternatively, the leading edge may be detected by the rapid change in voltage over a short time as seen at the end of Sample Period B in FIG. 2. Whatever method is used to detect the leading edge of the master's pulse, it may be used as the timing trigger to synchronize with the master's pulses.

In yet another alternative, the FMP transmitter master implements the sine wave modulation described by a FMP receiver embodiment as the timing trigger, wherein a critical predefined timing component is used by the FMP transmitter slaves to acquire the timing (e.g., the first peak, e.g., the second zero-crossing, e.g., the end of a synchronization message). All of these are possible implementations for FMP transmitters to acquire the timing profile, wherein the chosen implementation must match the method implemented by the master device to establish the synchronization timing for additional power transmitters (e.g., for FMP transmitters to use the sine wave to acquire their timing profile, the master device must be sending a sine wave to establish the synchronization timing).

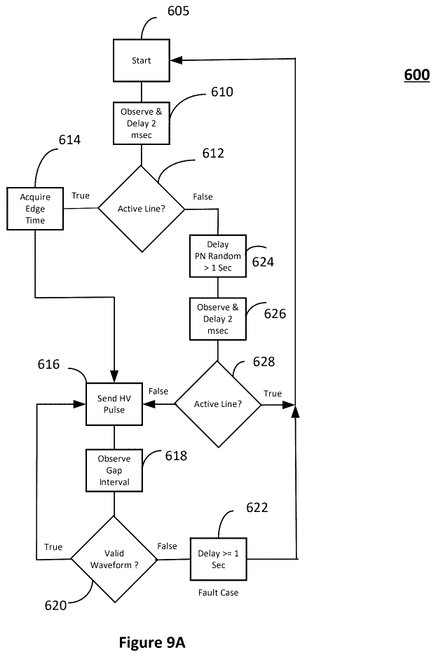

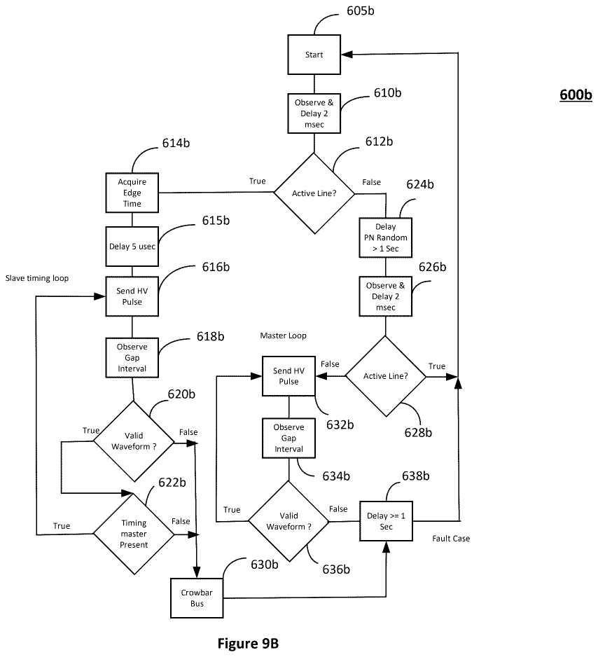

An embodiment of an algorithm to negotiate timing mastership among the FMP transmitters in the FMP system is shown in flow chart 600 of FIG. 9A. When a FMP transmitter first wakes up the algorithm running on its processor is started at step 605. At step 610 the common power bus is observed and then a 2 msec delay is implemented. After the delay, at step 612 the common bus is checked to see if high voltage power transmission is occurring. If it is, this indicates that another FMP transmitter is providing FMP output pulses to the common bus. If high voltage power transmission on the common bus is detected at step 612, the new FMP transmitter acquires the timing profile of the existing active FMP transmitter or transmitters at step 614 and will match this timing to ensure the interval between pulses matches what is measured.

At this point, the new FMP transmitter may also begin supplying power to the common power bus in the form of high voltage pulses at step 616, and monitoring the waveform seen on the common bus between each FMP pulse, during the sample period at step 618. At step 620 the waveform is checked if it indicates a fault condition or a no-fault condition. If no fault condition is detected, the system proceeds back to step 616 and transmits another high voltage pulse, and the loop continues by monitoring the waveform and checking for fault conditions (steps 618, 620). If, at step 620, a fault condition is detected, a delay (at least 1 second) is implemented at step 622 and the system loops back to the start, step 605.

Reverting back to step 612, if high voltage power transmission on the common bus is not detected, the system proceeds to step 624 where a random delay (greater than 1 second) is implemented and then at step 626, the common power bus voltage is measured and a 2 msec delay is implemented. After the delay, at step 628 the common bus voltage measured in step 626 is evaluated to see if high voltage power transmission is occurring. If the line is not active, the system proceeds from step 628 to step 616 where the FMP transmitter transmits a high voltage pulse, assuming the role of master. The process continues with steps 618, and 620 checking for faults in the sample period and continuing to transmit high voltage pulses at step 616. If the line is active, the system proceeds from step 628 to step 605 to the beginning of the flow chart.

If two or more power transmitters attempt to start-up at roughly, but not exactly the same time, the condition will be recognized by the FMP transmitters as a collision in that the observed pulsed current waveform will not be correct, and the FMP transmitters will execute a standard backoff arbitration algorithm as is common for shared communication lines.

In particular, each transmitter will delay a random or pseudo random time interval of at least one second before trying again. Pseudo random delays may be generated with a hash of the unique serial number of the transmitter providing the seed for a PN number generator. The minimum one second delay is to limit the amount of energy which may appear on the line before the next attempt, to ensure touch safety. A delay time other than 1 second may be chosen as needed to meet requirements, such as 3 seconds to comply with the Fault Recovery Period duration requirement in UL 1400-1.

Once a FMP transmitter is operating on the common power bus as the master it establishes the synchronization timing for additional power transmitters which join the network. When more than one FMP transmitter has successfully synchronized to the common power bus, the concept of a master becomes less important to the operation of a system since multiple power transmitters are now supporting the same synchronization timing. In this case, the original “master” can be disconnected, and the system will continue to operate normally provided the periodic connection of the predefined bias used for evaluating line capacitance is maintained in a known fashion (e.g., the FMP receiver is the device applying the bias, e.g., the number of FMP transmitters still connecting the bias periodically is known). Shared master operation is common to shared bus architectures and is sometimes called as “multi-master” architecture, such is exemplified by the well-known CAN bus protocol.

In the embodiment as shown in FIG. 9A, the loss of the original timing master is tolerated in that the remaining nodes are synchronized and maintain the same timing. In an alternative embodiment as exhibited in FIG. 9B, it is desirable that a unique timing master be maintained. In order to detect if the timing master has failed, the slave power transmitters may time their leading edge to trail by a short period of time behind the timing master. This short period of time is ideally kept as short as possible while still staying behind the timing master (e.g., on the order of microseconds); but in less optimal implementations, this period of time can be longer at the expense of reduced system performance if it provides a benefit, such as lower manufacturing cost by using wider tolerance components. Then, if the timing master has disappeared for several seconds, a fault condition is assumed and a rebidding for master can be initiated. Alternatively, the timing master may continue to assert itself through periodic message broadcasts in the shared communications channel.

Referring to FIG. 9B, and flow chart 600b, when a FMP transmitter first wakes up the algorithm running on its processor is started at step 605b, and at step 610b the common power bus is observed and then a 2 msec delay is implemented. After the delay, at step 612b the common bus is checked to see if high voltage power transmission is occurring. If it is, this indicates that another FMP transmitter is providing FMP output pulses to the common bus. If high voltage power transmission on the common bus is detected at step 612b, the new FMP transmitter acquires the timing profile of the existing active FMP transmitter or transmitters at step 614b and will match this timing to ensure the interval between pulses matches what is measured.

At step 615b, a 5 microsecond delay is implemented for at least the action taken based on acquiring the edge time (e.g., send a HV pulse in step 616b), and then the new FMP transmitter may also begin supplying power to the line in the form of high voltage pulses at step 616b. The transmitter will begin monitoring the waveform seen on the common bus between each FMP pulse, during the sample period at step 618b. At step 620b the waveform is checked if it indicates a fault condition or a no-fault condition. If no fault condition is detected, the system proceeds to step 622b where it is checked if the timing master is present. If the timing master is present, the system proceeds back to step 616b and transmits another high voltage pulse, and the loop continues by monitoring the waveform and checking for fault conditions (steps 618b, 620b) and checking for the presence of the timing master (step 622b). If, at step 620b, a fault condition is detected or at step 622b there is no master present, the system proceeds to “crowbar” the bus at step 630b to force a fault condition and after a delay of greater than one (1) second at step 638b, the system loops back to start step 605b.

Referring back to step 612b, if it is determined that the common bus is not active, the system proceeds to step 624 b for a delay (greater than 1 second) is implemented and then at step 626 b, the common power bus is observed and a 2 msec delay is implemented. After the delay, at step 628b the common bus is checked again to see if high voltage power transmission is occurring. If the line is not active, the system proceeds from step 628b to step 632b where the FMP transmitter transmits a high voltage pulse, assuming the role of master. The process continues to steps 634b and 636b checking for faults in the sample period and loops back to continuing to transmit high voltage pulses at step 632b. if there is an invalid waveform detected at step 636b, after a delay of greater than one (1) second at step 638b, the system proceeds to start step 605b. If the line was determined to be active at step 628b, the system proceeds to the start at step 605b.

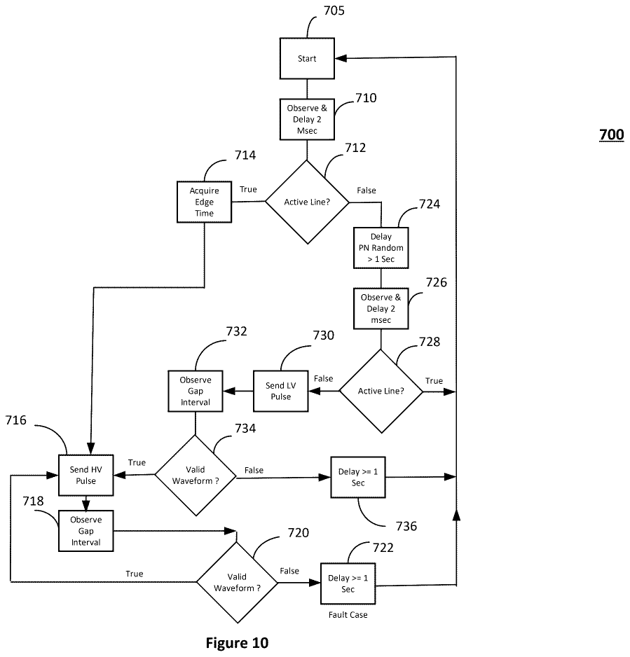

And yet another alternative embodiment of an algorithm to negotiate timing mastership among the FMP transmitters in the FMP system is shown in flow chart 700 of FIG. 10. This algorithm is similar to those described in FIGS. 9A and 9B, except that it starts at a low voltage, say 24 volts, and once timing mastership has been established, it will then increase the voltage to its high voltage operating condition of up to 450 volts. This algorithm has the added benefit of line probing being nearly imperceptible to anyone working with the wires. When starting up in a low voltage mode, a number of alternative embodiments are possible. In addition to the ones disclosed herein, others known in the art can be applied. For example, communications can be used at low voltages using known protocols, wherein this communication data can implement a discovery protocol such as the one described later in this disclosure.

Flow chart 700 is started at step 705, and at step 710 the common power bus is observed and then a 2 msec delay is implemented. After the delay, at step 712 the common bus is checked to see if the line is active, i.e. is high voltage power transmission is occurring. If it is, this indicates that another FMP transmitter is providing FMP output pulses to the common bus. If high voltage power transmission on the common bus is detected at step 712, the new FMP transmitter acquires the timing profile of the existing active FMP transmitter or transmitters at step 714 and will match this timing to ensure the interval between pulses matches what is measured.

At this point, the new FMP transmitter may also begin supplying power to the line in the form of high voltage pulses at step 716, and monitoring the waveform seen on the common bus between each FMP pulse, during the sample period at step 718. At step 720 the waveform is checked if it indicates a fault condition or a no-fault condition. If no fault condition is detected, the system proceeds back to step 716 and transmits another high voltage pulse and the loop continues by monitoring the waveform and checking for fault conditions (steps 718, 720). If, at step 720, a fault condition is detected, a delay (at least 1 second) is implemented at step 722 and the system loops back to the start, step 705.

Reverting back to step 712, if high voltage power transmission on the common bus is not detected, the system proceeds to step 724 for a delay (greater than 1 second) is implemented and then at step 726, the common power bus is observed and a 2 msec delay is implemented. After the delay, at step 728 the common bus is checked again to see if high voltage power transmission is occurring. If the line is active, the system proceeds from step 728 back to the start at step 705.

If at step 728 it is determined that the line is not active and no high voltage transmission is occurring, the system proceeds to step 730 where the new FMP transmitter may begin supplying power to the line in the form of low voltage FMP output pulses, and monitoring the waveform seen on the common bus between each FMP pulse, during the sample period at step 732. At step 734 the waveform is checked to see if it indicates a fault condition or a no-fault condition. If a no-fault condition is detected, the system proceeds to step 716 and transmits a high voltage pulse, and the loop continues by monitoring the waveform and checking for fault conditions (steps 718, 720). If at step 734 a fault condition is indicated, a delay (at least 1 second) is implemented at step 736 and the system loops back to the start, step 705.

One practical aspect of synchronization to factor into the design is timing delays. All synchronization signals are subject to at least the propagation delay of the signal traveling through its medium and any additional processing delays. It is understood that these delays must mitigated by any number of ways known in the art, and these can be used to define the most appropriate timing interval for the algorithm (e.g., the 5 microsecond delay of step 615b could be adjusted based on the timing delay analysis and chosen mitigation strategy). In the simplest method, where the delays are relatively short, such as when the distance between devices on the power bus is short, these delays can be factored into the timing tolerance by padding time intervals by the maximum possible delay. In other embodiments, calibration or other active methods can be employed as known in the art, including methods taught in U.S. Provisional App. No. 63/817,457.

In some embodiments, additional consideration is needed for startup aspects. One such embodiment is where the receiver provides the timing reference to be used by all of the power transmitters on a common power bus. At startup, the receiver must be provided with sufficient power to perform this task. This can be provided with a battery or from the grid in a grid tied system, or safely from one or more solar panels.

In an alternative embodiment that does not require a power source at the receiver, when a power transmitter first wakes up, it observes the common shared power bus to see if high voltage power transmission is already ongoing or if any other power transmitter is providing low voltage power to the shared bus. If not, a low voltage (typically below 24 volts and below 100 ma), current limited power is driven onto the power bus. This provides sufficient power to wake and power the receiver, but not enough voltage or current to do any harm to an individual or start a fire if a line fault or ground fault is present. It is desirable that only a single power module provide this “startup” power to prevent too much current being available on the power bus in the event of a short circuit between the conductors or to ground.

In another startup aspect applicable to systems configured with solar panels as the power sources for the power transmitters, in one embodiment, a power transmitter wakes up when there is sufficient sunlight on one or more of its directly attached solar panels to wake its electronics. At this point the flow chart of FIG. 6 is utilized to determine timing mastership.

Regardless of the startup method, once a receiver is powered up, in one embodiment, the receiver then modulates the power bus with a signal which may be used as a timing reference. The signal may be in the form of one or more pulses superimposed onto the power bus at regular intervals, or a higher frequency signal modulated onto the bus. The timing reference signal is then repeated at regular intervals for use by all of the power transmitters on the bus

In another alternative synchronization embodiment, a communications pulse string may be used to determine timing mastership. The leading edge of the message or the end of a message preamble may be used as the timing reference, and then used to compute the appropriate interval at which to initiate transmission.

Many methods of determining a timing master amongst FMP transmitters exist when utilizing communications. In one embodiment, if no pulses are detected during the random holdoff period (e.g., step 624b), the power transmitter performs its own transmission of an identification string. It also receives from the line during its transmission. If its own transmission is received unimpaired, then the power transmitter is the self-selected timing master and begins transmission of the test sequence necessary to verify there are no line faults and begin power transmission. If the transmission is impaired, then the power transmitter will compute another random delay interval before trying again.

When transmitting pulses for purposes of assuming mastership, a power transmitter unique sequence will be included in the string, so that collisions will always be detected, even if two nodes being transmission simultaneously. This is known in the prior art, and is similar to what is done in the well known “Aloha” transmission protocol for gaining access to a wireless channel. The Aloha protocol is described in https://en.wikipedia.org/wiki/ALOHAnet.

### FMP Power Module and Gateway Module

An important aspect of the FMP electrical power system of this disclosure is the power module that receives power from a power source and provides FMP output pulses via a FMP transmitter to the common bus. FIGS. 5-7 described above show different exemplary configurations of FMP power systems that power a common bus and how the power modules are used in these systems. In each example, some of the power modules are shown to be uni-directional devices, transmitting FMP output pulses to the common bus and some of the power modules are shown to be bi-directional devices that can transmit FMP output pulses to the bus with a FMP transmitter and can also receive FMP output pulses from the bus using a FMP receiver.

Gateway modules are also described above and shown in FIGS. 5-7 to be an interface between the common power bus and an electric grid, which may be a microgrid, a utility distribution grid, or a utility transmission grid, for example. Thus, the gateway module must be able to receive FMP output pulses from the common bus transmitted by the power modules that interface with the various power sources and convert the pulses to the electrical format required for connection to the electric grid. In a common case, the received DC pulses may be converted to DC power, and the DC power may be converted to AC using an inverter device. Alternatively, a higher DC voltage may be required, in which case a DC-DC converter may be included instead of or in addition to the inverter. The inclusion of a separate inverter or a DC-DC converter is not a requirement of this disclosure and may be implemented in different ways, including integrating the features into the FMP receiver such that the FMP output pulses may be rectified to DC before inversion or may be directly inverted from the FMP output pulses to AC.

The power modules and gateway modules may be configured as uni-directional devices, having only a FMP transmitter or a FMP receiver. For example, the FMP transmitter shown in FIG. 3 may be incorporated into a uni-directional power module to only transmit FMP pulses onto the common bus or the FMP receiver shown in FIG. 4 may be incorporated into a uni-directional gateway module to only receive FMP pulses from the common bus. Alternatively, the power modules and gateway modules may be configured as bi-directional devices having both a FMP transmitter and a FMP receiver. One embodiment may include a separate FMP transmitter, e.g. the FMP transmitter of FIG. 3, and a FMP receiver, e.g. the FMP receiver of FIG. 4, in parallel within the power module or gateway module, but more optimal embodiments are possible by eliminating redundant components common to FMP transmitters and FMP receivers, as would be obvious to one skilled in the art.

The bi-directional functionality is particularly applicable to an application like battery arrays since when the battery is discharging, the transmitter is responsible for safely managing the transmission of the battery energy over the common bus, but when the battery is subsequently charged, the transmitter would change functions to become a receiver and manage the reception of energy from the common bus to charge the battery. Thus, a more versatile power module or gateway may be configured as bi-direction devices, so that they may be used in both uni-directional applications (only enabling the required function) or they could be used in bi-directional applications requiring both transmitter and receiver functions.

At their most fundamental level, the devices, systems, and methods of this disclosure may utilize a plurality (i.e. two (2) or more) devices that include a FMP transmitter to synchronously deliver FMP output pulses over a common power bus for delivery to at least one (1) device that includes a FMP receiver. The devices may primarily include only the components required of a FMP transmitter and/or a FMP receiver or they may, but are not required to include, additional components like buck/boost converters shown in the power module device of FIG. 11 and in the gateway module of FIG. 12 or the inverter/rectifier in the gateway module.

In FIG. 11 there is shown an embodiment of a power module 1000 according to this disclosure and in FIG. 12 there is shown embodiment of a gateway module 1100 according to this disclosure. Both power module 1000 and gateway module 1100 are configured to be bi-directional so they can operate as FMP transmitters and FMP receivers, as would be required in power system 200 of FIG. 6 (for power source 215b and gateway modules 240a and 240b) and in power system 300 of FIG. 7 for all power modules and the gateway module. These bi-directional modules may be used in power system 100 of FIG. 5 with only the FMP transmitter functionality enabled or simpler uni-directional modules may be used. For system 100, power modules 120, 125, and 130 may have FMP transmitter capability only while gateway module may have FMP receiver capability only.

While the power module and gateway module are described herein in FIGS. 11 and 12 as utilizing a digital signal processor to perform many functions by executing code stored in memory, including the FMP power transmitter and receiver functions, this is not a requirement of this disclosure. The term processing circuitry as used herein includes digital signal processors, microprocessor(s) with various architectures like single/multi-processor, field-programmable gate arrays (FPGA), application-specific integrated circuits (ASIC), and other processing circuitry. Implementation of the functionality described herein with respect to a digital signal processor, using various other types of processing circuitry may be readily accomplished by a person skilled in the art and are therefore not described in detail.

Specifically, with respect to FMP synchronization, one such prior art is U.S. application Ser. No. 18/504,603, which discloses a synchronization circuit and method that primarily uses the large change and voltage when the transmitter turns back on. Other prior art examples of synchronization are U.S. application Ser. No. 18/197,440 disclosing approaches including RF and U.S. Pat. No. 12,237,773 disclosing additional hardware sensing circuits and methods. Neither of these address the issue of synchronizing multiple transmitters on the same shared bus.

In both the power module 1000 and the gateway module 1100 at the connection to the common bus there is included a “crowbar” circuit. Crowbar circuits are used in fault conditions to clamp the positive transmission line to ground or negative, driving the lines to a safe, low differential voltage. A crowbar circuit in the power modules and the gateway modules will provide protection for a transmitter that is continuing to energize the transmission line, despite the line being in a fault condition. The crowbar circuit must be designed to absorb the transient current for a single pulse from all of the parallel power transmitters in a power system, along with the full continuous source current of at least one power transmitter channel, allowing for one faulty transmitter on the common bus.

The crowbar circuit may comprise a switch 1005/1105 (e.g. a FET) operated under the control of processor 1010/1110 in power module 1000 and gateway module 1100, respectively. Processors 1010 and 1110 may be a digital signal processor or other type of processor which includes an analog to digital converter for converting and measuring analog waveforms. Switches 1005/1105 must be able to support the sustained output power of at least one defective FMP transmitter.

With respect to power module 1000, the power from power source port 1030 is coupled to buck power supply 1025 via diode 1032 when it is forward biased. Capacitor 1034 is charged when power passes through diode 1032 and discharges to provide power to buck power supply 1025, as needed. The power from power bus port 1015 through internal bus 1070 is also coupled to buck power supply 1025 via diode 1036 when it is forward biased. Capacitor 1034 is also charged when power passes through diode 1036. Depending on whether diode 1032 is forward biased or diode 1036 is forward biased, buck mode power supply 1025 converts power at power source port 1030 from the connected power source (e.g. one of the solar panels 115a-g of FIG. 5) from the power source voltage to a low voltage or converts power at internal bus 1070 from the power bus port 1015 from the internal bus voltage to a low voltage, wherein the low voltage is approximately 1.8 volts or whatever low voltage is required by processor 1010.

There is also included a bidirectional buck/boost mode power supply 1035, which in forward boost mode upconverts power at power source port 1030 from the connected power source to a higher voltage level for generation of the FMP output pulses to the common bus connected at power bus port 1015. As an example, solar panels typically output power at <50 volts, and the FMP output power pulses will typically be between 300 volts and 450 volts. With solar panels, this forward boost mode can be designed such that it performs maximum power point tracking (MPPT) for each solar panel to maximize the energy utilization from each panel.

When power module 1000 is operating as a FMP receiver, the received FMP output pulses at power bus port 1015 are allowed to pass into power module 1000 when switch 1050 is closed and switch 1026 is opened. When the pulses are received, diode 1055 is forward biased and allows the pulses to pass from power bus port 1015 and charge capacitor 1060. The voltage of capacitor 1060 will be equal to the voltage of the FMP output pulses received minus the diode forward voltage drop, i.e. typically in the 300-450 volts range. Bidirectional buck/boost mode power supply 1035 will be operated in reverse buck mode to down convert the voltage to the voltage level of the power source, i.e. typically <50 volts, to output DC power on power source port 1030 to a rechargeable battery, for example.

When power module 1000 is operating as a FMP transmitter, switch 1050 is typically opened and switch 1026 is controlled by processor 1010 to close to produce FMP output pulses during power transfer period and to open during sample period. The capacitor 1060 provides the power for the FMP output pulses, typically in the 300-450 volts range. When operating in either mode, an example waveform of FMP pulses and sample periods is depicted in FIG. 2. If the internal bus 1070 is kept high enough during sample periods to keep diode 1055 reverse biased, switch 1050 is not required to be opened, which may be advantageous when switching seamlessly between sending and receiving power during power transfer periods.

Processor 1010 is responsible for controlling the transmission and reception of FMP pulses by controlling switches 1026 and 1050, characterizing the line for faults, evaluating the power bus waveform for derivation of timing, and for modulating control signals onto the bus and receiving control signals from the bus. The voltage across and current through resistor 1040 is sensed at power bus port 1015 by analog processing circuit 1020 and delivered to processor 1010. The voltage and current information may be used by processor 1010 to, for example, control the FMP output pulses to adjust current output and voltage at the point of connection to the common bus for power management and load sharing purposes, as described below.

Modulation and demodulation can be performed by analog modulation and receiver 1027, under the control of processor 1010, for end-to-end communications during sampling periods, status updates, security, or node identification. It may also be used to receive the timing trigger from a FMP receiver for synchronizing the FMP transmitter pulse output. Alternatively or in addition, switch 1028 and resistor 1024, under the control of processor 1010, may produce modulated signals on the common bus to be used for inline communications during sample periods Switch 1028 and resistor 1024 may also be used as a fault inducing circuit in order to force a bus fault if resistor 1024 has a low enough resistance to simulate a fault condition, and it is applied continuously through one or more gaps, all of the transmitters on the shared bus will detect a fault condition.

Analog scaling and protection device 1045 scales the input and shifts voltage to be compatible with the A/D converter channels in the processor 1010. Level shifting and scaling are well understood technologies in the state of the art and therefore are not further disclosed here.

The output of analog scaling and protection device 1045 is analyzed by processor 1010 to acquire the leading edge of a FMP pulse from a master FMP transmitter (referred to herein as a timing trigger) also connected to the common bus. From this timing trigger, processor 1010 may derive the timing signal enabling it to produce FMP pulses synchronized with the master's output pulses. This is part of the timing synchronization process so power module 1000 can synchronize with the master FMP transmitter's output pulses during power transfer periods and the master FMP transmitter sample periods where the master FMP transmitters does not output pulses and when the bus is checked for fault conditions. An exemplary waveform being assessed for faults is depicted in FIG. 2 and would be observed by the processor 1010 during the sample periods. The timing synchronization process by power module 1000 is shown in FIG. 9A and B, for example.

If the droop during the sample period is greater than or less than expected, then the common bus is in a fault condition. If the voltage droop on the common bus is as expected, then the sharp rising trailing edge of the sample period may be detected and with knowledge of the sample period length, the beginning of the sample period may be estimated. This information is used by the power module 1000 (and other “slave” devices connected to the common bus) to know when to open their main switches for the start of the next sample period and subsequently close their main switches for power transfer periods in a synchronized manner. It should be noted that if the common bus voltage is non-zero volts but also completely flat (rather than decaying as it should be), then there is a critical timing skew between the FMP transmitters that are transmitting on the common bus, and the FMP transmitter of power module 1000; or there is a hardware failure within one of the devices connected to the power bus. If this were to occur, power module 1000 may not enter active high voltage mode, step 616 of flow chart 600 in FIG. 9A.

A communications device 1065 may be included to enable communications between the power module 1000 and other devices in the power system, such as other power modules, gateway modules, separate management/control devices, or other devices via separate hardwired data lines or wireless communications. The timing triggers for synchronizing the FMP transmitters of the power modules and gateway devices may be transmitted and received via communications device 1065, instead of or in addition to the timing triggers being provided via the common power bus by the master FMP transmitter (i.e. the leading edge of the FMP pulses, which may be used to derive a timing signal by the processor) or by a FMP receiver by modulating the timing signal (trigger) onto the FMP pulses as described above. Irrespective of how the timing trigger/signals are transmitted and received, they are used by the power modules, gateway devices, and any other device having FMP transmitter functionality connected to a common power bus to synchronize the transmission of FMP pulses, as described above. These timing triggers may be referred to herein as “external” timing triggers, meaning they are produced external of the device receiving the timing triggers and using them for synchronization purposes. It should be understood that the leading edge of a FMP pulse from a master FMP transmitter (referred to herein as a timing trigger) does constitute an external timing trigger even though the processor may use the timing trigger to derive the timing signal enabling it to produce FMP pulses synchronized with the master's output pulses.

With respect to gateway module 1100, an embodiment is shown in FIG. 12. There are many components in gateway module 1100 common to the components in power module 1000 and such components are labelled with comparable reference numbers. For example the processor is labeled 1010 for power module 1000 and it is labeled 1110 for gateway module 1100. So, the leading two digits are either 10 (power module) or 11 (gateway module) and the last two digits are the same if they are referring to the same component (e.g. 10 for the processor). An additional device, inverter/rectifier device 1175, is included with gateway module 1110 at its power grid port 1130 to invert DC power to AC and output it to the electric grid when the gateway module is operating as a FMP receiver. Where the grid may be a DC voltage such as with microgrids, this inverter/rectifier device may be a DC/DC converter.

Inverter/rectifier device 1175 can also operate as a rectifier to convert AC or DC from the electric grid to DC power when the gateway module is operating as a FMP transmitter. Inverter/rectifier 1175 may include one or more transformers and provide galvanic isolation from the grid. In this case, the conductors labeled 1115 including the lower “Common Conductor” may be electrically isolated from the grid. Inverters, rectifiers and DC to DC converters are well understood in the state of the art, and are therefore not described in additional detail in this disclosure. It may also be possible to configure inverter/rectifier 1175 to perform the buck/boost functions of device 1135, so that buck/boost device 1135 may be eliminated. When describing and claiming the gateway module 1100 herein, devices 1175 may be individually referred to as a converter or together they may be referred to as a “converter”.

The other components in gateway module 1100, operate in the same manner as the components in power module 1000 to perform FMP transmission and reception.

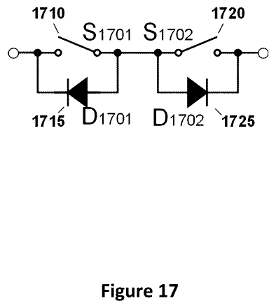

With respect to switch 1026, switch 1050, and diode 1055 in the power module 1000, while FIG. 11 shows a typical arrangement to demonstrate the functionality required by these elements, alternative embodiments exist for bidirectional operation. In one alternative, switch 1026 is replaced by the back-to-back FET arrangement shown in FIG. 17, and switch 1050 and diode 1055 are removed. While switch (S₁₇₀₁) 1710 and switch (S₁₇₀₂) 1720 are depicted with a separate diode (D₁₇₀₁) 1715 and diode (D₁₇₀₂) 1725, respectively, each switch and diode pair may be embodied by a single component, such as a MOSFET that features a body-diode effect. These alternative switch arrangements apply similarly to the analogous elements in the gateway module 1100 shown in FIG. 12.

This switch arrangement allows comprehensive coverage of all required states for FMP transmitter and FMP receiver operation. As a FMP transmitter during the power transfer period, switch (S₁₇₀₁) 1710 and switch (S₁₇₀₂) 1720 are closed. Optionally, switch (S₁₇₀₂) 1720 can remain open such that diode (D₁₇₀₂) 1725 blocks any possible back-feeding from the power bus. As a FMP transmitter during the sample period, switch (S₁₇₀₁) 1710 and switch (S₁₇₀₂) 1720 are opened. Optionally, switch (S₁₇₀₂) 1720 can be closed if any benefit is appreciated (e.g., reduced stress from switching on switch (S₁₇₀₂) 1720) provided that the internal bus 1070 is high enough relative to the power bus to keep diode (D₁₇₀₁) 1715 reverse biased. As a FMP receiver during the power transfer, switch (S₁₇₀₁) 1710 is opened and switch (S₁₇₀₂) 1720 is closed to allow power flow from the power bus to the internal bus 1070 without allowing back-feeding due to the blocking action of diode (D₁₇₀₁) 1715. Optionally, switch (S₁₇₀₁) 1710 can be closed to effectively operate as synchronous rectification to appreciate reduced power loss in certain ranges of operation. As a FMP receiver during the sample period, the switch configuration options and conditions are the same as a FMP transmitter during the sample period.

Note the possible optimizations possible above, where as a FMP transmitter, switch (S₁₇₀₂) 1720 can either remain opened or remain closed for both the power transfer period and the sample period provided the conditions above are met. This further demonstrates an optimization wherein, if the power module will only operate as a FMP transmitter, switch (S₁₇₀₂) 1720 and diode (D₁₇₀₂) 1725 can be omitted altogether and each of their 2 terminals electrically connected; or only switch (S₁₇₀₂) 1720 can be omitted to keep the back-feeding blocking diode (D₁₇₀₂) 1725 in the circuit at all times if the losses are acceptable. Similarly, where as a FMP receiver, switch (S₁₇₀₂) 1720 can remain closed for both the power transfer period and the sample period, or switch (S₁₇₀₁) 1710 can remain open for both the power transfer period and the sample period. Alternative optimizations are possible to allow removal of components if the power module will only operate as a FMP receiver, including removing switch (S₁₇₀₂) 1720 and diode (D₁₇₀₂) 1725 to be replaced by shorting each of their terminals, or removing switch (S₁₇₀₁) 1710.

In typical embodiments, power module 1000 includes capacitor 1060 as shown in FIG. 11. In alternative embodiments, it is possible to eliminate this capacitor if the internal bus 1070 is stable enough from the bidirectional buck/boost 1035 and/or the power bus connected at power bus port 1015. This may further require switch 1050 and switch 1026 to remain open during sample periods to ensure the lack of capacitor 1060 does not result in a fault detected by any of the FMP transmitters connected to the power bus (e.g., such as when diode 1055 is not kept reverse biased). Similarly, capacitor 1034 would typically be included, but capacitor 1034 can be omitted if not required by the buck power supply. These optimizations would also be possible for the analogous elements in the gateway module 1100.

In some embodiments, the power modules and/or gateway modules may require a bias to be known in order to detect excessive line-to-line capacitance during sample period fault detection. One way to accomplish this is to assign only one FMP transmitter to apply the bias, for example the FMP transmitter acting as the master in a master/slave operation for synchronizing the FMP transmitter output pulses (which are described below). Despite only one transmitter applying the bias, all transmitters can perform the analysis to detect if there is excessive line-to-line capacitance. This redundancy would also be able to detect the lack of a master transmitter's bias activation since there would be no significant difference between the analysis results captured with and without the bias applied. In the event that the master is lost and a new master must be determined, this would require that process to be completed prior to the time when the next line-to-line capacitance check is required. Alternatively, a gateway device can be the device that applies the bias. A bias may be applied by switching a resistor to apply a bias across the line to perform a controlled discharge of the line and ascertain its line-to-line capacitance and/or line-to-line resistance, as is known by those skilled in the art. Instead of using a resistor, the bias may be applied with a current source or sink.

In another embodiment using a known bias, power transmitters can each apply their own known bias, and communications can be utilized to allow each transmitter to factor in the total number of transmitters that applied the bias. The most common embodiment of this method would be for all transmitters to apply their biases. In this embodiment, each individual transmitter could use a weaker bias based on the minimum number of transmitters supported in the installation, allowing circuit layout and component cost optimization, so long as the aggregate of all transmitter biases is sufficient for line-to-line capacitance detection. In a similar method, transmitters can each apply their own known bias, and they can each factor in the configured maximum number of transmitters. This simplifies the implementation, but it can make fault sensing overly sensitive.

### Power Management and Load Sharing

During start-up or after a fault, in order to prevent too many solar panels and batteries, and associated power modules from being installed onto the common power bus, the FMP transmitters may participate in a discovery protocol where they announce their presence to the FMP receiver and obtain permission from the receiver to participate in power delivery. Following a fault condition, all of the transmitters on the common bus send messages to the active FMP receiver requesting permission to deliver power. This message may be passed as a modulated signal on the common bus itself, or out of band through an external communications bus, or via an RF network such as Bluetooth or Wifi. In some embodiments, signaling is included in the sample period between power transfer periods. The receiver counts the number of unique requests by tracking the serial numbers of the requestors (not shown in the diagram), and acknowledges power delivery until a preprogrammed limit is reached. At this time the receiver delivers a denial message to additional requests. At startup and whenever a fault is detected, the receiver resets its counter and collection of requestors.

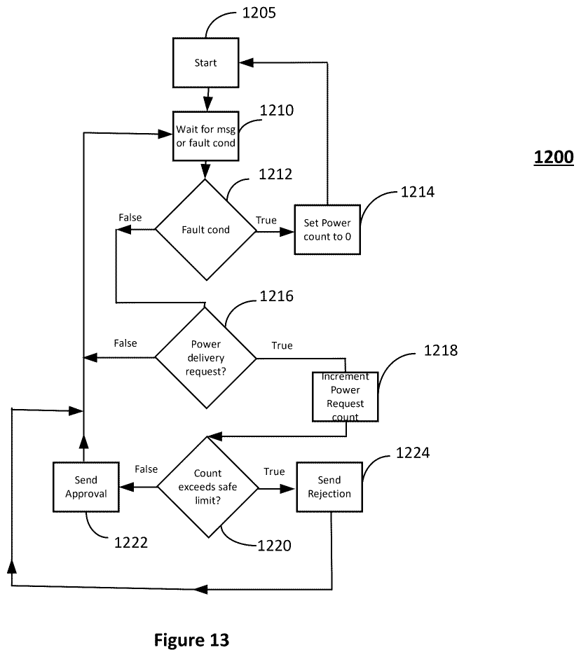

An embodiment of this discovery protocol, which may be implemented in a FMP receiver, is shown in flow chart 1200, FIG. 13. The protocol starts at step 1205 and then waits for a message from a FMP transmitter or a notice of a fault condition on the common power bus at step 1210. At step 1212, the system determines if it is a transmitter message or if there has been a fault detected. In the case of a fault detection, the system sets the FMP transmitter count to zero at step 1214 and proceeds to start step 1205. If a fault condition was not detected at step 1212, the system proceeds to step 1216 to check if a FMP transmitter has made a power delivery request. If no request has been made, the system returns to step 1210 and waits for a message from a FMP transmitter or a notice of a fault condition on the common power bus. If at step 1216, a transmitter has made a request the system proceeds to step 1218 where the transmitter power request count is incremented and at step 1220, it is determined if the transmitter request count exceeds the predetermined safe limit for the common power bus. If the count is not exceeded, at step 1222 the system sends an approval to the transmitter sending the power request and returns to step 1210 to wait for another transmitter request or a fault notification. If at step 1220, the count exceeds the predetermined safe limit, at step 1224 a rejection is sent to the transmitter requesting to deliver power to the common bus and the system returns to step 1210 to wait for another transmitter request or detection of a fault condition.

Discovery can be done as in a centralized fashion where one device coordinates the messages. In an alternative embodiment, the discovery process can be handled in a distributed fashion, where all devices receive the messages from all other devices and are able to all come to the same conclusion regarding the timing master using a predefined convention (e.g., the lowest unique ID is the timing master).

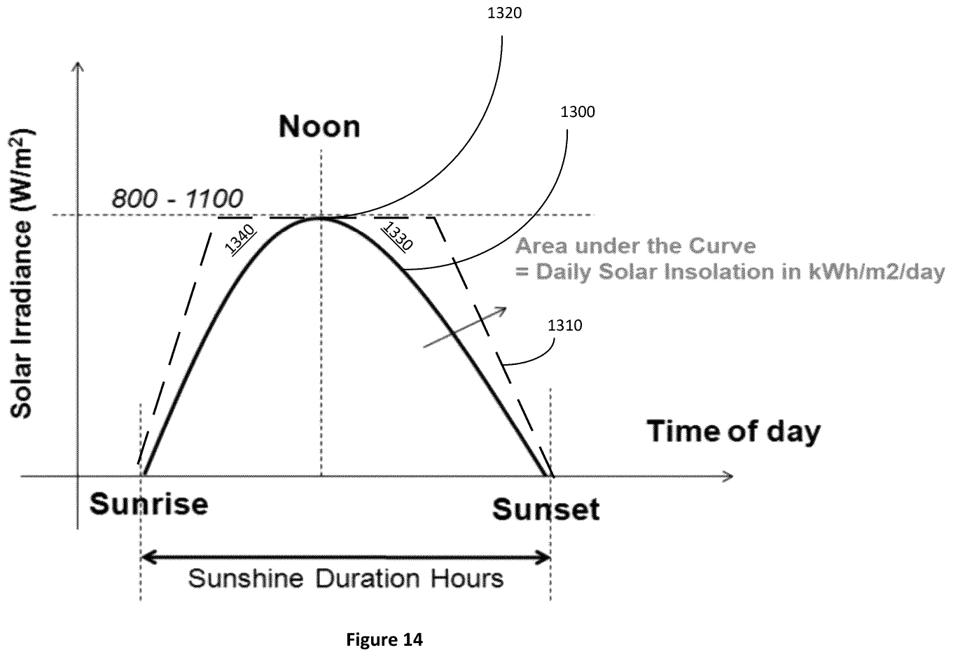

In an alternative embodiment to the above-described discovery protocol, a FMP receiver may simply restrict the amount of current it will accept from the common power bus, such that any additional power transmitters will simply render excess capacity. Such excess capacity will not be drawn upon, except during shoulder hours such as dawn and dusk, increasing the effective capacity factor of the solar power system. In a conventional solar power system, under an open cloudless sky, the power derived from solar panels will closely match the solid solar insolation curve 1300, which is shown in FIG. 14. If excess capacity is installed on the string, as shown under the dotted line 1310, the peak power 1320 remains the same, but the total power is increased by the amount shown between the two curves, areas 1330 and 1340.

In some embodiments the power sources driving the power modules are only solar panels without local energy storage. In this case, it is not necessary that current loads be uniformly distributed among the panels. In this case all of the power transmitters output at approximately the same voltage. Power draw will follow the highest voltage providers or those with the lowest impedance to the receiver along the power bus. If the power receiver load is not at its minimum value such that it is drawing its rated amount of current, then some power transmitters will not deliver power, or at least not until shoulder periods where sun intensity dips and power from every power transmitter on the bus will be required to reduce any current decline at the power receiver during normal on periods.

In other embodiments, the power source may include solar with attached distributed energy storage, typically in the form of distributed batteries or super capacitors affixed underneath some or all of the solar panels. In this case, uniform power delivery from each panel is desirable for storage management purposes to ensure uniform wear of the storage media. Here dynamic modulation of the output voltage may be used on a per power transmitter basis to ensure that all panels with storage participate in delivering power

In one embodiment the power transmitters load share by adjusting their output voltage according to the current flowing through them. As current for one transmitter increases, its voltage very slightly decreases, allowing other modules to share the load.

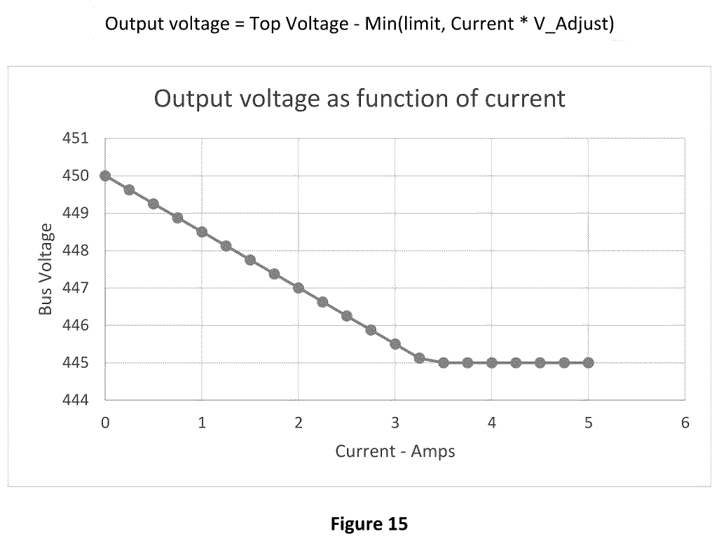

An example of a voltage/current profile is shown in FIG. 15. Here the voltage is calculated as: Output voltage=Top Voltage−Min(limit, Current*V_Adjust). Top Voltage is the maximum bus voltage supported. Limit is the lowest aggregate decrement which is allowed. In this example the limit is set to 5 volts and so transmitters won't deliver power below 445 volts. The V_Adjust parameter is a scaling factor for the current.

Modules may be shipped with these variables pre-established, or more ideally they may be established dynamically during operations. For example, when obtaining permission to join the bus, transmitters could be notified of their operating parameters. As more transmitters join the bus, all of the transmitters can be updated with new parameters, thereby ensuring relatively uniform load sharing even from modules with different capabilities.

Among the operating parameters that can be disclosed are parameters corresponding to the cable of the power bus as well as the cable of the connections between each power module and the power bus. These parameters can take a number of forms, but a common practical one is the distance between each electrical node connection as well as the resistance per foot of each cable, wherein an electrical node connection is defined as any of an end device connection (e.g., power module, receiver, gateway module, etc.) as well as any intermediary branching circuit connection between 2 end devices. With this information, the impedance between each node can be calculated, and the optimal voltage for each transmitter can be calculated for current sharing without relying on real-time data from other end devices.

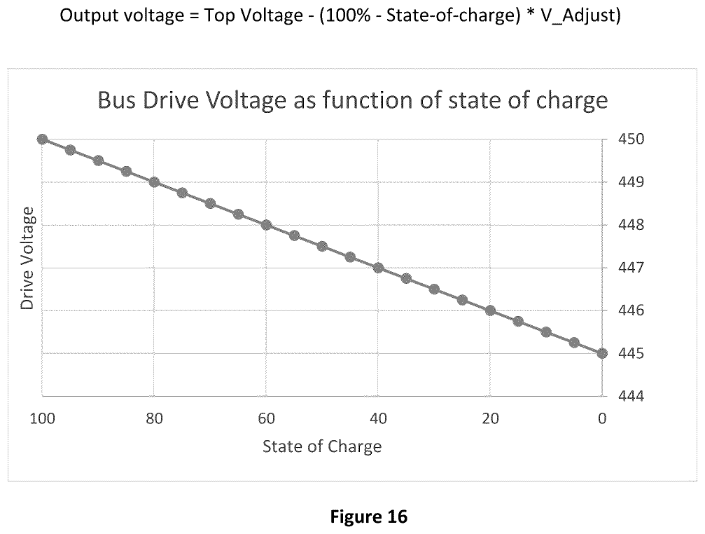

In another embodiment, where the objective is battery balancing, instead of current balancing, state of charge may be utilized. This is shown in FIG. 16. The power module with an attached battery having the highest state of charge will deliver the highest voltage. As the state of charge declines, then the voltage being driven onto the bus will similarly decline, ensuring other batteries participate in delivering power. An additional variation is to blend these two parameters, where both the current state of charge and current are considered.

In another embodiment, the power transmitters execute a round robin method for preference in delivery of power by slightly increasing or decreasing their voltages on a rotating basis. A higher voltage output gets to deliver more power, but only until its voltage dips under the load or becomes dominated by other power modules, for example as its battery is depleted. In one variation, this round robin method is performed based on time slots; wherein these time slots can be coordinated through communication, or the information to derive these time slots can be at least partially predefined (e.g., a predefined maximum number of power modules and time slots are a subdivision of the synchronization period), or the time slot usage can be based on randomization. In another variation, this round robin method is performed based on battery charge. After a power module's battery is depleted by a certain percentage, the power transmitter slightly reduces its output voltage to allow other power transmitters to take the lead.

It is understood that, while the most common and cost-effective implementations use the transmitter or receiver to perform functions such as monitoring for safety faults and sending permission signals, a different device distinct from those can be used to encapsulate a subset of operations, and this device may be termed a management device. For example, a device that does not participate in power delivery (i.e., neither transmitting nor receiving) on the power bus could nevertheless perform the monitoring or send the permission signal, where the discovery of a fault initiates a signal from the monitoring device such as a crowbar or other signaling to the other transmitters to terminate power delivery. In one example, a management device to dictate the synchronization signal and permission signal is embodied by the gateway device 1100 with the omission of at least the power grid bus 1130, bidirectional buck/boost 1135, inverter/rectifier 1170, diode 1132, and capacitor 1134. In another example, a management device that only provides out-of-band communications via communication device 1065/1165 may be configured similar to a power module 1000 with its own power source or gateway module 1100, but may not require any PET front-end components. The subdivision and repackaging of elements contained within the power module and the gateway module is a design choice that can be made by one of ordinary skill in the art and is considered an equivalent disclosed embodiment.

The various embodiments of the disclosure described above are intended to be merely exemplary; numerous variations and modifications will be apparent to those skilled in the art. All such variations and modifications are intended to be within the scope of the present disclosure as defined in any appended claims.

Without limitation, potential subject matter that may be claimed (prefaced with the letter “P” so as to avoid confusion with the actual claims presented below) includes:
P1. A fault managed power (FMP) electrical power system, comprising:
   a plurality of electrical power sources:
   a plurality of power module devices each electrically connected to one or more of the plurality of power sources at an power source port; each power module device, comprising:
      an power bus port;
      at least one switch between the power source port and the power bus port;
      first processing circuitry configured to control the at least one switch to receive power from the first electrical power source and to transmit FMP output pulses via the power bus port over the common electrical bus; wherein the first processing circuitry is configured to receive an external timing trigger to enable the processing circuitry to synchronize the transmission of the FMP output pulses with the transmission of FMP output pulses from each of the other of the plurality of power module devices; and
   a FMP gateway module connected at an power bus port to the common electrical bus and configured to receive the synchronized FMP output pulses from the common electrical bus, the FMP gateway module comprising:
      an power grid port configured to be connected to an electric grid;
      at least one switch between the power bus port and the power grid port;
      second processing circuitry configured to control the at least one switch to receive the synchronized FMP output pulses from the common electrical bus;
      a converter device connected to the at least one switch and configured to output a required form of power to the electric grid.
P2. The FMP electrical power system of potential claim 1, wherein the first processing circuity includes a first digital signal processor and the second processing circuit includes a second digital signal processor.
P3. The FMP electrical power system according to any one of the above potential claims, wherein a voltage level of the FMP output pulses is substantially equivalent to the voltage level of the FMP output pulses of the other of the plurality of power module devices.
P4. The FMP electrical power system according to any one of the above potential claims, wherein the first processing circuitry is configured to transmit the FMP output pulses synchronized with the FMP output pulses of the other of the plurality of power module devices during power transfer periods and wherein the first processing circuitry is configured to cease transmission of FMP output pulses during sample periods between power transfer periods.
P5. The FMP electrical power system according to any one of the above potential claims, wherein the first processing circuitry is configured to monitor the common electrical bus for faults during sample periods and, if a fault is detected, to control the at least one switch to terminate the transmission of FMP output pulses to the common electrical bus.
P6. The FMP electrical power system according to any one of the above potential claims, wherein the first electrical power source is one or more of a solar power source, a battery power source, and a generator power source.
P7. The FMP electrical power system according to any one of the above potential claims, wherein the first electrical power source includes a battery power source and wherein the battery power source is rechargeable.
P8. The FMP electrical power system according to any one of the above potential claims, wherein the converter device is configured to receive power from the electric grid in the required form of power for the electric grid and convert the power from the electric grid to DC power; and wherein the second processing circuitry is configured to control the at least one switch to receive the DC power and to transmit FMP output pulses over the common electrical bus; wherein the second processing circuitry is configured to receive the external timing trigger to enable the second processing circuitry to synchronize the transmission of the FMP output pulses with the transmission of FMP output pulses from the plurality of power module devices
P9. The FMP electrical power system according to any one of the above potential claims, wherein the first processing circuitry is configured to control the at least one switch to receive the synchronized FMP output pulses from one or more of the other of the plurality of power module devices or from the FMP gateway module from the common electrical bus.
P10. The FMP electrical power system according to any one of the above potential claims, wherein the first processing circuitry is configured to operate as a master and synchronize transmission of the FMP output pulses from the other of the plurality of power module devices and the gateway module using a master-slave process.
P11. The FMP electrical power system according to any one of the above potential claims, wherein the second processing circuitry is configured to operate as a master and synchronize transmission of the FMP output pulses from the plurality of power module devices using a master-slave process.
P12. The FMP electrical power system according to any one of the above potential claims, wherein the first processing circuitry is configured to operate as a slave and receive the external timing trigger from one of the other of the plurality of power module devices or the gateway module operating as a master.
P13. The FMP electrical power system according to any one of the above potential claims, wherein the second processing circuitry is configured to operate as a slave and receive the external timing trigger from one of the plurality of power module devices operating as a master.
P14. The FMP electrical power system according to any one of the above potential claims, wherein the first processing circuitry is configured to receive the external timing trigger from one of i) one of the other of the plurality of power module devices, ii) the gateway module, or iii) a management device.
P15. The FMP electrical power system of claim 35, wherein the external trigger is a modulated timing signal on the FMP pulses by one of the other of the plurality of power module devices or the at least one FMP receiver.
P16. The FMP electrical power system according to any one of the above potential claims, wherein the second processing circuitry is configured to receive the external timing trigger from one of i) one of the plurality of power module devices, or ii) a management device.
P17. The FMP electrical power system according to any one of the above potential claims, wherein the external trigger is a modulated timing signal on the FMP pulses by one of the plurality of power module devices.
P18. The FMP electrical power system according to any one of the above potential claims, wherein the first and second processing circuitry are configured to output current based on one or more of a power requirement of the gateway module, an impedance of the common electrical bus, and a voltage at the output of the plurality of power module devices.
P19. The FMP electrical power system according to any one of the above potential claims wherein the first processing circuitry is configured to adjust the voltage of the FMP output pulses in order share the power load with the other of the plurality of electrical power sources.
P20. The FMP electrical power system according to any one of the above potential claims wherein the second processing circuitry and each of the other of the plurality of power module devices are configured to adjust the voltage of the FMP output pulses based on a state of charge of the rechargeable battery.
P21. The FMP electrical power system according to any one of the above potential claims, wherein the first and second processing circuitry are configured to selectively apply a predetermined bias voltage during sample periods.
P22. The FMP electrical power system according to any one of the above potential claims, wherein the first and second processing circuitry are configured to detect a fault based on a predetermined aggregate bias applied by one or more of the power modules and the gateway module during a sample period.
P23. The FMP electrical power system according to any one of the above potential claims, wherein the FMP power module is configured to be connected in parallel to the common electrical bus.
P24. The FMP electrical power system according to any one of the above potential claims, wherein the FMP gateway module further includes a capacitor connected between the output of the at least one switch and the converter device to receive the FMP output pulses and output DC power to the converter device.
P25. The FMP electrical power system according to any one of the above potential claims, including a capacitor connected to the at least one switch and configured to receive the FMP output pulses and output DC power; and further including a converter device connected the capacitor to convert the DC power from a first voltage level to a second voltage level.

What is claimed is:

1. A fault managed power (FMP) transmitter configured to connect a first electrical power source to a common electrical bus as part of an FMP electrical system; wherein the FMP electrical system also includes at least one FMP receiver and at least one other FMP transmitter, each connected to the common electrical bus, the FMP transmitter comprising:
a source port configured to be connected to the at least one electrical power source;
a power bus port configured to be electrically connected to the common electrical bus;
at least one switch between the source port and the power bus port;
processing circuitry configured to control the at least one switch to receive power from the first electrical power source and to transmit FMP output pulses via the power bus port over the common electrical bus to the FMP receiver; wherein the processing circuitry is configured to receive an external timing trigger to enable the processing circuitry to synchronize transmission of the FMP output pulses with the transmission of FMP output pulses over the common electrical bus from the at least one other FMP transmitter connected to one of the first electrical power source or a second electrical power source.

2. The FMP transmitter of claim 1, wherein the at least one other FMP transmitter is connected to the first electrical power source to output FMP pulses over the common electrical bus.

3. The FMP transmitter of claim 1, wherein the at least one other FMP transmitter is connected to the second electrical power source to output FMP pulses over the common electrical bus.

4. The FMP transmitter of claim 1, wherein the processing circuity includes a digital signal processor.

5. The FMP transmitter of claim 1, wherein a voltage level of the FMP output pulses is substantially equivalent to the voltage level of FMP output pulses of the at least one other FMP transmitter.

6. The FMP transmitter of claim 1, wherein the processing circuitry is configured to transmit the FMP output pulses synchronized with the FMP output pulses of the at least one other FMP transmitter during power transfer periods and wherein the processing circuitry is configured to cease transmission of FMP output pulses during sample periods between power transfer periods.

7. The FMP transmitter of claim 6, wherein the processing circuitry is configured to monitor the common electrical bus for faults during sample periods and, if a fault is detected, to control the at least one switch to terminate the transmission of FMP output pulses to the common electrical bus.

8. The FMP transmitter of claim 7, wherein the first electrical power source is one or more of a solar power source, a battery power source, and a generator power source.

9. The FMP transmitter of claim 8, wherein the first electrical power source includes a battery power source and wherein the battery power source is rechargeable.

10. The FMP transmitter of claim 1, wherein the processing circuitry is configured to control the at least one switch to receive the synchronized FMP output pulses from the common electrical bus.

11. The FMP transmitter of claim 10, further including a capacitor connected to the at least one switch to receive the synchronized FMP output pulses and to output DC power and a first converter device connected to the capacitor and configured to convert the DC power from a first voltage level to a second voltage level; wherein the FMP transmitter and the converter device are integrated into an FMP power module device and wherein the at least one FMP receiver is integrated into a gateway module including a second converter configured to receive the output of the FMP receiver, convert the output to a form of power required for an electric grid.

12. The FMP transmitter of claim 1, wherein the processing circuitry is configured to synchronize transmission of the output pulses using a master-slave process.

13. The FMP transmitter of claim 12, wherein the processing circuitry is configured to operate as a master and the at least one other FMP transmitter operates as slaves.

14. The FMP transmitter of claim 12, wherein the processing circuitry is configured to operate as a slave and receive the external timing trigger from the at least one other FMP transmitter operating as a master.

15. The FMP transmitter of claim 14, wherein the external timing trigger is one of a modulated timing signal on the FMP output pulses or a leading edge of a FMP output pulse from the at least one other FMP transmitter operating as the master.

16. The FMP transmitter of claim 1, wherein the processing circuitry is configured to receive the external timing trigger from one of i) the at least one other FMP transmitter, ii) the at least one FMP receiver, or iii) a management device.

17. The FMP transmitter of claim 13, further configured to one of generate a modulated timing signal on the FMP output pulses as the timing trigger or output FMP output pulse from which the at least one other FMP transmitter uses the leading edge as the timing trigger.

18. The FMP transmitter of claim 1, wherein the processing circuitry is configured to output current based on one or more of a power requirement of the FMP receiver, an impedance of the common electrical bus, and a voltage at the output of the at least one other FMP transmitter.

19. The FMP transmitter of claim 1, wherein the processing circuitry and the at least one other FMP transmitter are configured to adjust the voltage of the FMP output pulses in order share the power load with the first and second electrical power sources.

20. The FMP transmitter of claim 9, wherein the processing circuitry and the at least one other FMP transmitter are configured to adjust the voltage of the FMP output pulses based on a state of charge of the rechargeable battery.

21. The FMP transmitter of claim 6, wherein the processing circuitry is configured to selectively apply a predetermined bias voltage during sample periods.

22. The FMP transmitter of claim 6, wherein the processing circuitry is configured to detect a fault based on a predetermined aggregate bias applied by the FMP transmitter and the at least one other FMP transmitter during a sample period.

23. The FMP transmitter of claim 1, wherein the FMP transmitter is configured to be connected in parallel to the common electrical bus.

24. The FMP transmitter of claim 1, wherein there are more than two electrical power sources, together constituting a plurality of electrical power sources, and there are more than at least one other FMP transmitter, together constituting a plurality of other FMP transmitters; and wherein each of the plurality of other FMP transmitters is connected to at least one of the plurality of electrical power sources; and wherein each of the plurality of other FMP transmitters are connected to the common power bus and output synchronized FMP output pulses.

25. A method for transferring fault managed power (FMP) from a first electrical power source to a common electrical bus via a FMP transmitter in a FMP electrical system; wherein the FMP electrical system also includes at least one FMP receiver and at least one other FMP transmitter, each connected to the common electrical bus, the method comprising:
connecting the first electrical power source to a first FMP transmitter having at least one switch;
connecting the first FMP transmitter to the common electrical bus;
controlling the at least one switch to receive power from the first electrical power source and to transmit FMP output pulses over the common electrical bus; and
wherein the step of controlling includes receiving an external timing trigger to enable transmission of the FMP output pulses of the first FMP transmitter to be synchronized with the transmission of FMP output pulses by the at least one other FMP transmitter.

26. The method of claim 25, including connecting the at least one other FMP transmitter to the first electrical power source to output FMP pulses over the common electrical bus.

27. The method of claim 25, including connecting the at least one other FMP transmitter to the second electrical power source to output FMP pulses over the common electrical bus.

28. The method of claim 25, wherein a voltage level of the FMP output pulses of the first FMP transmitter are substantially equivalent to the voltage level of FMP output pulses of the at least one other FMP transmitter.

29. The method of claim 25, including transmitting the FMP output pulses of the first FMP transmitter synchronized with the FMP output pulses of the at least one other FMP transmitter during power transfer periods and ceasing transmission of FMP output pulses of the first transmitter and of at least one other FMP transmitter during sample periods between power transfer periods.

30. The method of claim 29, including monitoring the common electrical bus for faults during sample periods and, if a fault is detected, controlling the at least one switch to terminate the transmission of FMP output pulses to the common electrical bus.

31. The method of claim 30, wherein the first electrical power source is one or more of a solar power source, a battery power source, and a generator power source.

32. The method of claim 31, wherein the first electrical power source includes a battery power source and wherein the battery power source is rechargeable.

33. The method of claim 25, including controlling the at least one switch to receive the synchronized FMP output pulses from the common electrical bus.

34. The method of claim 33, including connecting a capacitor to the at least one switch to receive the synchronized FMP output pulses and output DC power and connecting a first converter device to the capacitor to convert the DC power from a first voltage level to a second voltage level; wherein the method further includes integrating the FMP transmitter and the first converter device into an FMP power module device and integrating the at least one FMP receiver into a gateway module including providing a second converter to receive the output of the FMP receiver, convert the output to a form of power required for an electric grid.

35. The method of claim 25, including synchronizing transmission of the output pulses using a master-slave process.

36. The method of claim 35, including operating the first FMP transmitter as a master and operating the at least one other FMP transmitter as a slave.

37. The method of claim 35, including operating the first FMP transmitter as a slave and receiving the external timing trigger from the at least one other FMP transmitter operating as a master.

38. The method of claim 37, wherein the external timing trigger is a leading edge of a FMP output pulse or a modulated timing signal on the FMP output pulses from of the at least one other FMP transmitter operating as the master.

39. The method of claim 25, including receiving the external timing trigger from one of i) the at least one other FMP transmitter, ii) the at least one FMP receiver, or iii) a management device.

40. The method of claim 36, including the first FMP transmitter undertaking one of generating a modulated timing signal on the FMP output pulses as the timing trigger or providing an FMP output pulse from which the at least one other FMP transmitter uses the leading edge as the timing trigger.

41. The method of claim 25, including using the first FMP transmitter to output current based on one or more of a power requirement of the FMP receiver, an impedance of the common electrical bus, and a voltage at the output of the at least one other FMP transmitter.

42. The method of claim 25, including controlling the first transmitter and the at least one other FMP transmitter to adjust the voltage of the FMP output pulses in order share the power load with the first and second electrical power sources.

43. The method of claim 32, including adjusting the voltage of the FMP output pulses based on a state of charge of the rechargeable battery.

44. The method of claim 30, including selectively applying a predetermined bias voltage using the first FMP transmitter during sample periods.

45. The FMP transmitter of claim 30, including detecting by the first FMP transmitter a fault based on a predetermined aggregate bias applied by the first FMP transmitter and the at least one other FMP transmitter during a sample period.

46. The FMP transmitter of claim 25, including connecting the first FMP transmitter in parallel to the common electrical bus.

47. The method of claim 25, further including providing more than two electrical power sources, together constituting a plurality of electrical power sources, and providing more than at least one other FMP transmitter, together constituting a plurality of other FMP transmitters; and including connecting each of the plurality of other FMP transmitters to at least one of the plurality of electrical power sources and connecting each of the plurality of other FMP transmitters to the common power bus to output synchronized FMP output pulses.

48. A fault managed power (FMP) receiver for use in an electrical power system, wherein the electrical power system includes at least one power source connected to a common electrical bus via at least two FMP transmitters, the FMP receiver comprising:
a power bus port configured to be connected to the common electrical bus and configured to receive synchronized FMP output pulses from the at least two FMP transmitters transmitted over the common electrical bus;
a power grid port configured to be connected to an electric grid;
at least one switch between the power bus port and the power grid port; and
processing circuitry configured to control the at least one switch to receive the synchronized FMP output pulses from the common electrical bus.

49. The FMP receiver of claim 48, further including a converter device connected to the at least one switch and configured to output a required form of power to the electric grid; wherein the converter device and the FMP receiver are integrated into a gateway module.

50. The FMP receiver of claim 48, wherein the processing circuity includes a digital signal processor.

51. The FMP receiver of claim 48, wherein the FMP receiver controls the at least one switch to receive FMP output pulses during power transfer periods from the at least two FMP transmitters and wherein the FMP receiver controls the at least one switch disconnect from the common power bus when the at least two FMP transmitters cease transmission of FMP output pulses during sample periods between power transfer periods.

52. The FMP receiver of claim 51, wherein the processing circuitry is configured to monitor the common electrical bus for faults during sample periods and, if a fault is detected, it is configured to send a signal to the at least two FMP transmitters to terminate transmission of FMP output pulses to the common electrical bus.

53. The FMP receiver of claim 51, wherein the first electrical power source is one or more of a solar power source, a battery power source, and a generator power source.

54. The FMP receiver of claim 53, wherein the first electrical power source includes a battery power source and wherein the battery power source is rechargeable.

55. The FMP receiver of claim 49, wherein the converter device is configured to receive power from the electric grid in the required form of power for the electric grid and output converted power; and wherein the processing circuitry is configured to control the at least one switch to receive the converted power and to transmit FMP output pulses over the common electrical bus; wherein the processing circuitry is configured to receive an external timing trigger to enable the processing circuitry to synchronize the transmission of the FMP output pulses with the transmission of FMP output pulses from the at least two FMP transmitters.

56. The FMP receiver of claim 55, wherein the processing circuitry is configured to operate as a master and synchronize transmission of the FMP output pulses from the at least two FMP transmitters using a master-slave process.

57. The FMP receiver of claim 55, wherein the processing circuitry is configured to operate as a slave and receive the external timing trigger from one of the at least two FMP transmitters operating as a master.

58. The FMP receiver of claim 55, wherein the processing circuitry is configured to receive the external timing trigger from one of i) one of the at least two FMP transmitters, or ii) a management device.

59. The FMP receiver of claim 58, wherein the external trigger is a modulated timing signal on the FMP pulses by one of the at least two FMP transmitters.

60. The FMP receiver of claim 55, wherein the processing circuitry is configured to output current based on one or more of an impedance of the common electrical bus and a voltage at the output of the at least two FMP transmitters.

61. The FMP receiver of claim 55, wherein the processing circuitry is configured to adjust a voltage of the FMP output pulses based on a state of charge of a power source including a rechargeable battery.

62. The FMP receiver of claim 55, wherein the processing circuitry is configured to selectively apply a predetermined bias voltage during sample periods.

63. The FMP receiver of claim 55, wherein the processing circuitry is configured to detect a fault based on a predetermined aggregate bias applied by one or more of the at least two FMP transmitters and the FMP receiver during a sample period.

64. The FMP receiver of claim 49, further including a first capacitor connected between the output of the at least one switch and the converter device to receive the FMP output pulses and output DC power to the converter device.

65. The FMP receiver of claim 55, further including a second capacitor connected between the output of the at least one switch and the converter device to receive the required form of power from the electric grid and output DC power to the at least one switch.

66. A method for receiving fault managed power (FMP) by an FMP receiver in an electrical power system, wherein the electrical power system includes at least one power source connected to a common electrical bus via at least two FMP transmitters, the method comprising:
connecting a power bus port of the FMP receiver to the common electrical bus to receive synchronized FMP output pulses from the at least two FMP transmitters;
connecting a power grid port to an electric grid;
connecting at least one switch between the power bus port and the power grid port;
controlling the at least one switch to receive the synchronized FMP output pulses from the common electrical bus.

67. The method of claim 66, further including connecting a converter device to the at least one switch to output a required form of power to the electric grid and integrating the converter device and the FMP receiver into a gateway module.

68. The method of claim 66, wherein the processing circuity includes a digital signal processor.

69. The method of claim 66, including controlling the at least one switch to receive the FMP output pulses transmitted by the at least two FMP transmitters during power transfer periods and controlling the at least one switch to disconnect from the common power bus when the at least two FMP transmitters cease transmission of ceasing transmission of FMP output pulses during sample periods between power transfer periods.

70. The method of claim 69, including monitoring by the FMP receiver the common electrical bus for faults during sample periods and, if a fault is detected, sending a signal to the at least two FMP transmitters to terminate transmission of FMP output pulses to the common electrical bus.

71. The method of claim 69, wherein the first electrical power source is one or more of a solar power source, a battery power source, and a generator power source.

72. The method of claim 71, wherein the first electrical power source includes a battery power source and wherein the battery power source is rechargeable.

73. The method of claim 67, including receiving via the converter device power from the electric grid in the required form of power for the electric grid and outputting converted power from the converter device; the method further including controlling the at least one switch to receive the converted power and to transmit by the FMP receiver FMP output pulses over the common electrical bus; wherein the step of controlling includes receiving an external timing trigger to enable the FMP receiver to synchronize the transmission of the FMP output pulses with the transmission of FMP output pulses from the plurality of power module devices.

74. The method of claim 73, including operating the FMP receiver as a master and synchronizing transmission of the FMP output pulses from the at least two transmitters using a master-slave process.

75. The method of claim 73, includes operating the FMP receiver as a slave and receiving the external timing trigger from one two FMP transmitters operating as a master.

76. The method of claim 73 includes receiving by the FMP receiver the external timing trigger from one of i) one of at least two FMP transmitters, or ii) a management device.

77. The method of claim 76, including modulating the external trigger timing signal on the FMP pulses by one of the at least two FMP transmitters.

78. The method of claim 73 including outputting current by the FMP receiver based on one or more of an impedance of the common electrical bus and a voltage at the output of the at least two FMP transmitters.

79. The method of claim 72, includes adjusting a voltage of the FMP output pulses transmitted by the FMP receiver based on a state of charge of a power source including a rechargeable battery.

80. The method of claim 73, causing the FMP receiver to selectively apply a predetermined bias voltage during sample periods.

81. The method of claim 73, includes detecting by the FMP receiver a fault based on a predetermined aggregate bias applied by one or more of the at least two FMP transmitters and the FMP receiver during a sample period.

82. The method of claim 67 including connecting a first capacitor between the output of the at least one switch and the converter device and receiving the FMP output pulses by the capacitor and outputting DC power to the converter device.

83. The method of claim 73, further including connecting a second capacitor between the output of the at least one switch and the converter device to receive the required form of power from the electric grid and output DC power to the at least one switch.
